(19) United States
(12) Patent Application Publication
(10) Pub. No.: US 2023/0121813 A1
(43) Pub. Date: Apr. 20, 2023

(54) RECYCLE METHOD OF POLISHING AGENT SLURRY AND RECYCLE SYSTEM OF POLISHING AGENT SLURRY

(71) Applicant: KONICA MINOLTA, INC., Tokyo (JP)

(72) Inventors: Atsushi TAKAHASHI, Tokyo (JP); Akihiro MAEZAWA, Tokyo (JP)

(73) Assignee: KONICA MINOLTA, INC., Tokyo (JP)

(21) Appl. No.: 17/900,614

(22) Filed: Aug. 31, 2022

(30) Foreign Application Priority Data
Oct. 19, 2021 (JP) 2021-170616
Mar. 3, 2022 (JP) 2022-032208

(51) Int. Cl. B24B 37/34; C09G 1/02; B01D 21/00; B01D 21/28

(52) U.S. Cl. CPC B24B 37/34; C09G 1/02; B01D 21/0012; B01D 21/283

(57) ABSTRACT

Provided is a method for recycling a polishing agent slurry comprising: a first process including a slurry collecting process of collecting the used polishing agent slurry discharged from a polishing device; a desalting treatment process of reducing an ion concentration of the collected polishing agent slurry; and a dispersion treatment process of dispersing the polishing agent component and the constituent component of the object to be polished by adding a pH adjusting agent and a dispersing agent to the desalted polishing agent slurry; and after the first process, a second process of preparing a recycled polishing agent slurry from the polishing agent component by separating the polishing agent component and the constituent component of the object to be polished.

### CROSS-REFERENCE TO RELATED APPLICATIONS

The entire disclosures of Japanese Patent Application No. 2021-170616 filed on Oct. 19, 2021 and Japanese Patent Application No. 2022-032208 filed on Mar. 3, 2022 are incorporated herein by reference in its entirety.

### BACKGROUND

### Technological Field

The present invention relates to a method for recycling a polishing agent slurry and a system for recycling a polishing agent slurry. More specifically, when a polishing agent recycling treatment for removing a constituent component (glass component) of an object to be polished from a used polishing agent slurry used for polishing glass is performed, the present invention relates to a method for recycling a polishing agent slurry having excellent separability between an abrasive grain component containing cerium oxide and the constituent component (glass component) of the object to be polished.

### Description of the Related Art

In the precise polishing process of glass and the chemical mechanical polishing (CMP) process in semiconductor manufacturing, rare earth oxides such as cerium oxide are used as polishing agents (also called “polishing materials” or “abrasive grains”). Polishing processes using cerium oxide as a polishing agent are carried out in the finishing processes of various products such optical glasses, cover glass of smartphones, and cover glass of automotive displays, as well as in the CMP processes of silicon oxide layers of semiconductors.

In the polishing process of glass or the CMP process of semiconductors, cerium oxide is generally supplied to the polishing device as a slurry in which fine particles of cerium oxide are dispersed in water, and a polishing cloth or a brush is pressed against the glass. Polishing is carried out by moving relative to each other while applying pressure.

In the CMP process, an excellent polishing performance is obtained due to chemical action that is induced, in addition to physical force, when abrasive grains containing cerium oxide come into contact with an object to be polished. Therefore, in the CMP process, it is important that the abrasive grains are stably dispersed in the slurry without agglomeration. In addition, when the abrasive grains in the polishing agent slurry agglomerate to form large particles, the polishing process is likely to cause scratches and other defects on the object to be polished. Therefore, it is also important to stably disperse the abrasive grains in the polishing agent slurry from the viewpoint of processing quality.

As described above, cerium oxide is commonly used in the CMP process of the object to be polished mainly composed of silicon. Since cerium oxide is unevenly produced in the world, and the process of extracting cerium oxide from minerals containing cerium oxide has a high environmental impact, it is strongly desired to use the precious resource effectively.

In order to effectively use cerium oxide, there is known a method of collecting and recycling the polishing agent from a cerium oxide polishing agent slurry that has been used in the CMP process. For example, Patent Document 1 (Japanese Patent No. 6292119) discloses a polishing agent collection method in which a cerium oxide polishing agent is recycled from a used polishing agent slurry containing a cerium oxide polishing agent that has been used to polish a material whose main component is silicon. In the disclosed collection method of a cerium oxide polishing agent, specifically, an inorganic salt is added to the collected cerium oxide polishing agent slurry in a condition where pH of the mother liquid at 25° C. is 7 to 10, such that the polishing agent is agglomerated separately from the component derived from the polished material. The agglomerated polishing agent is separated from the mother liquid and concentrated, and then dispersed again by adding a dispersing agent.

In addition, Patent Document 2 (Japanese Patent No. 5850192) and Patent Document 3 (Japanese Patent No. 5843036) also disclose a collection method of a cerium oxide polishing agent from a used polishing agent slurry. More specifically, the method includes collecting a polishing agent from a polishing agent slurry that has been used to polish a material including silicon as a main component. In this method, a solvent is added without using a pH adjusting agent such that particles of a material that has been polished are dissolved, and then the polishing agent slurry is filtered to collect the polishing agent.

In recent years, in order to enhance the optical or physical function and properties of glass, in addition to the base material (for example, silicon), various metals are increasingly added. In addition, from the viewpoint of effective utilization of cerium oxide, which is a rare earth resource, in order to increase its utilization efficiency (glass processing amount per abrasive mass), from the start of use to the disposal of abrasive grains of cerium oxide, polishing is often carried out for as long as possible. Therefore, there are increasing cases where the content of the object to be polished (glass component) and the content of components such as metals eluted from the object to be polished (glass) (ionic component) contained in the used polishing agent slurry, further, the content of the ionic component derived from the pH adjusting agent added for the purpose of adjusting the pH of the polishing agent slurry during processing are increased.

In such a case, in the used polishing agent slurry containing a large amount of the glass component, an ionic component dissolved from the glass, and an ionic component derived from a pH adjusting agent, it is easy to take a gelled structure of the glass component itself. Further, it was found that the abrasive particles and the glass component have formed aggregates, and it is difficult to efficiently separate the abrasive particles and the glass component even if the known technique is applied.

### SUMMARY

The present invention has been made in view of the above problems and circumstances. An object of the present invention is to provide a method for recycling an polishing agent slurry having excellent separability between an abrasive grain component containing cerium oxide and a constituent component (glass component) of an object to be polished, and a system for recycling a polishing agent slurry, when performing a polishing agent recycle process for removing constituent component (glass component) of an object to be polished from a used polishing agent slurry used for polishing glass.

The present inventor has found the following in the process of examining the cause of the above problem in order to solve the above problem.

When removing the constituent component of the object to be polished from the used polishing agent slurry containing the constituent component of the polishing agent and the constituent component of the object to be polished, it was used a recycle method of a polishing agent containing: a desalting treatment process for reducing the ion concentration of the collected used polishing agent slurry; and a specific process including a dispersion process of dispersing the polishing agent component and the constituent component of the object to be polished with adding a pH adjusting agent and a dispersing agent to the desalted polishing agent slurry. It was found that a recycle method of a polishing agent slurry having excellent separability between an abrasive grain component composed of cerium oxide and a component (glass component) of an object to be polished can be obtained.

The above problems related to the present invention are solved by the following means.

To achieve at least one of the above-mentioned objects of the present invention, a recycle method of a polishing agent slurry that reflects an aspect of the present invention is as follows.

A method for recycling a polishing agent slurry to remove a constituent component of an object to be polished from a used polishing agent slurry containing a polishing agent component and the constituent component of the object to be polished, and to collect and recycle the polishing agent component, the method comprising:

a first process including: a slurry collecting process of collecting the used polishing agent slurry discharged from a polishing device;

a desalting treatment process of reducing an ion concentration of the collected polishing agent slurry; and

a dispersion treatment process of dispersing the polishing agent component and the constituent component of the object to be polished by adding a pH adjusting agent and a dispersing agent to the desalted polishing agent slurry; and

after the first process, a second process of preparing a recycled polishing agent slurry from the polishing agent component by separating the polishing agent component and the constituent component of the object to be polished.

A recycle method of a polishing agent slurry that reflects another aspect of the present invention is as follows.

A method for recycling a polishing agent slurry to remove a constituent component of an object to be polished from a used polishing agent slurry containing a polishing agent component and the constituent component of the object to be polished, and to collect and recycle the polishing agent component, the method comprising:

a first process including: a slurry collecting process of collecting the used polishing agent slurry discharged from a polishing device;

a desalting treatment process of adjusting an ion concentration of the collected polishing agent slurry to be 0.3 mS/cm or less as an electrical conductivity value at 25° C. equivalent; and

a dispersion treatment process of dispersing the polishing agent component and the constituent component of the object to be polished by adding a pH adjusting agent to the desalted polishing agent slurry to adjust a pH value of the used polishing agent slurry at 25° C. equivalent to be 8.0 or more; and

after the first process, a second process of preparing a recycled polishing agent slurry from the polishing agent component by separating the polishing agent component and the constituent component of an object to be polished.

By the above means of the present invention, when performing a polishing agent recycle process that removes a constituent component (glass component) of an object to be polished from a used polishing agent slurry used for polishing glass, it is possible to provide a method for recycling an polishing agent slurry having excellent separability between an abrasive grain component containing cerium oxide and a constituent component (glass component) of an object to be polished, and a system for recycling a polishing agent slurry.

Although the mechanism of expression or mechanism of action of the effect of the present invention has not been clarified, it is inferred as follows.

The present inventor found the following. In a used polishing agent slurry containing a large amount of glass component that is a polished object, an ionic component derived from glass, and an ionic component derived from a pH adjusting agent, it is easy for the glass component to take a gel structure. Further, the abrasive grains and the glass component have formed aggregates, and it is difficult to separate the abrasive grains and the glass component which is the object to be polished even if a known technique is applied.

In the process of examining the cause of the above problem in order to solve the above problem, the following may be inferred. In the presence of a component to be polished, an ionic component eluted from the component to be polished, an ionic component derived from a pH adjusting agent, and a metal ion mixed in the process from use as a polishing agent to collection, contained in the recycled polishing agent, it is easy to take a structure in which the glass component itself contained in the polishing agent slurry is gelled. In addition, the polishing agent particles and the glass component form an agglomerate, the dispersion stability of the abrasive grains is lowered, and the abrasive grain component becomes an agglomerated state.

As a countermeasure to this, as a method for removing dissolved ionic components contained in the used polishing agent slurry (also referred to as “desalting treatment” in the present invention), it is conceivable that the solid content composed of cerium oxide and glass and the solution in which the ionic component is dissolved are separated into solid and liquid by filter filtration or centrifugation to efficiently remove the dissolved ionic component.

As a method for sufficiently removing the ionic component, it is conceivable to carry out the above solid-liquid separation operation as follows. The used polishing agent slurry is once diluted with water and then stirred to elute the ionic components adhering to the abrasive grains into the slurry, and then the solid-liquid separation operation is performed.

Regarding the dispersion of the abrasive grain component containing cerium oxide and the glass component aggregate contained in the used polishing agent slurry after the separation, it is considered that the agglomerated state may be eliminated by adjusting the pH value of the slurry with a pH adjusting agent and performing a dispersion treatment by adding a dispersing agent to the cerium oxide and the glass component in the agglomerated state.

It is preferable to add the pH adjusting agent and the dispersing agent so that the surface potentials of the abrasive grain component containing cerium oxide and the glass component contained in the slurry are in phase with each other. In the dispersion treatment, it is more preferable to apply energy such as ultrasonic waves in addition to stirring.

In the separation of the abrasive grain component containing cerium oxide and the glass component, by performing the above treatment, the cerium oxide abrasive grain and the glass component are made in a dispersed state in the slurry being recycled. Since the glass component has a sufficiently small size and a low density as compared with the cerium oxide abrasive grains, it may be easily separated by a method such as sedimentation separation or filtration separation.

Therefore, when the average particle size (D50) of the abrasive grains containing cerium oxide is larger than about 0.5 μm, a sufficient separation rate may be obtained even by a sedimentation separation method such as a natural sedimentation method. When intending to increase the separation rate of the abrasive grains containing cerium oxide and the glass component, or when the particle size of the cerium oxide abrasive grains is relatively small and the separation process takes time for separation by natural sedimentation, as in a known example, by adding a salt, cerium oxide abrasive grains may be selectively aggregated to increase the sedimentation rate. In addition, a centrifuge using centrifugal force, a cyclone type powder grader may be used, or the separation process may be carried out by a filtration filter.

By adopting the above desalting treatment process and dispersion treatment process as a first process of the method for recycling the polishing agent slurry, it is possible to realize a method for recycling a polishing agent slurry having excellent separability between an abrasive grain component composed of cerium oxide and a glass component which is a component of an object to be polished.

On the other hand, the abrasive grain component containing cerium oxide contained in the used polishing agent slurry and the glass component constituting the object to be polished are easily aggregated in the slurry under the influence of the ion component contained in the slurry.

Therefore, in order to disperse the abrasive grain component containing cerium oxide and the glass component contained in the polishing agent slurry, it is necessary to remove the ion component. In addition to this, it is important it is important to control the surface potential of the abrasive grain component containing cerium oxide and the glass component in each liquid.

It is known that the surface potential of particle components present in a liquid varies depending on the pH value of the liquid. The abrasive grain component containing cerium oxide has an isoelectric point near pH 7.0 at which the surface potential becomes zero. The surface potential is positive on the acidic side of the isoelectric point, and it is negative on the alkaline side of the isoelectric point.

On the other hand, it is known that the isoelectric point of the glass component is around pH value of 2.0, the surface potential is positive on the acid side of the isoelectric point, and the surface potential is negative on the alkaline side of the isoelectric point.

Since there is a relationship as described above, after sufficiently removing the ion components contained in the used polishing agent slurry, it was found that by adjusting the pH value at 25° C. equivalent to alkaline, it becomes possible to disperse the aggregated abrasive grain component containing cerium oxide and the glass component without adding a dispersing agent.

In addition, by returning the pH value at 25° C. equivalent of the used polishing agent slurry in the dispersed state to near neutrality, the surface potential of the abrasive grain component containing cerium oxide approaches zero (isoelectric point). A phenomenon was observed in which the electrostatic repulsive force decreased and the abrasive grain component containing the cerium oxide selectively aggregated again.

That is, by adjusting the pH value, the abrasive grain component containing cerium oxide is selectively aggregated again, so that the sedimentation rate is increased, and it is possible to improve the processing rate of the separation and concentration process.

Compared to the case of natural sedimentation, since the glass component enters inside the agglomerate of the abrasive grain component containing cerium oxide, it is slightly disadvantageous to natural sedimentation from the viewpoint of the removal rate of the glass component. However, since the natural sedimentation rate of the cerium oxide particles is very slow, especially in polishing agent slurry with a small cerium oxide particle size, intentional agglomeration increases the sedimentation rate, which is practically advantageous.

### BRIEF DESCRIPTION OF THE DRAWINGS

The advantages and features provided by one or more embodiments of the invention will become more fully understood from the detailed description given hereinbelow and the appended drawing which are given by way of illustration only, and thus are not intended as a definition of the limits of the present invention.

FIG. 1 is a schematic diagram showing an example of a basic process flow of a method for recycling a polishing agent slurry.

FIG. 2 is a schematic diagram showing an example of a first process flow.

FIG. 3 is a schematic diagram showing an example of a second process flow.

### DETAILED DESCRIPTION OF THE EMBODIMENTS

Hereinafter, one or more embodiments of the present invention will be described. However, the scope of the invention is not limited to the disclosed. However, the scope of the invention is not limited to the disclosed embodiments.

The method for recycling the polishing agent slurry of the present invention is a method for recycling a polishing agent slurry to remove a constituent component of an object to be polished from a used polishing agent slurry containing a polishing agent component and a constituent component of an object to be polished; and to collect and recycle the polishing agent component. This recycling method contains: a first process including a slurry collecting process of collecting the used polishing agent slurry discharged from a polishing device; a desalting treatment process of reducing an ion concentration of the collected polishing agent slurry; and a dispersion treatment process of dispersing the polishing agent component and the constituent component of the object to be polished by adding a pH adjusting agent and a dispersing agent to the desalted polishing agent slurry. After the first process, this recycling method contains: a second process of preparing a recycled polishing agent slurry from the polishing agent component by separating the polishing agent component and the constituent component of the object to be polished. This feature is a technical feature common to or corresponding to the following embodiments.

As an embodiment of the present invention, from the viewpoint of exhibiting the effect of the present invention, it is preferable that the second process contains: a separation and concentration process of separating the polishing agent component and the constituent component of the object to be polished by natural sedimentation, centrifugation, sedimentation separation by adding a salt, or filter filtration; and a polishing agent recycle process of preparing a recycled polishing agent slurry from the separated and concentrated polishing agent component. This is preferable from the viewpoint of efficiently recycling the polishing agent slurry.

In the desalting treatment process, it is preferable that the desalting treatment is performed so that an ion concentration of the used polishing agent slurry is 5.0 mS/cm or less, more preferably 1.0 mS/cm or less as an electrical conductivity value at 25° C. equivalent. It is preferable from the viewpoint of obtaining excellent separability between the abrasive grain component composed of cerium oxide and the constituent component of the object to be polished.

In the dispersion treatment process of the first process, the pH value at 25° C. equivalent of the used polishing agent slurry is adjusted to 6.0 or more by the pH adjusting agent, and the dispersing agent is added in the range of 0.1 to 5.0% by mass with respect to the mass of the polishing agent contained in the used polishing agent slurry. This is preferable from the viewpoint of obtaining excellent separability between the abrasive grain component composed of cerium oxide and the constituent component of the object to be polished.

The pH adjusting agent is preferably an inorganic acid, a carboxylic acid, an amine base or ammonium hydroxide, and the dispersing agent is preferably a water-soluble anionic dispersing agent, a water-soluble cationic dispersing agent or a water-soluble amphoteric dispersing agent. It is preferable from the viewpoint of facilitating the separation of the abrasive grain component composed of cerium oxide and the glass component which is a constituent component of the object to be polished.

Another embodiment of the present invention is a recycle method of a polishing agent slurry in the following.

A method for recycling a polishing agent slurry to remove a constituent component of an object to be polished from a used polishing agent slurry containing a polishing agent component and the constituent component of the object to be polished, and to collect and recycle the polishing agent component, the method comprising:

a first process including: a slurry collecting process of collecting the used polishing agent slurry discharged from a polishing device;

a desalting treatment process of adjusting an ion concentration of the collected polishing agent slurry to be 0.3 mS/cm or less as an electrical conductivity value at 25° C. equivalent; and

a dispersion treatment process of dispersing the polishing agent component and the constituent component of the object to be polished by adding a pH adjusting agent to the desalted polishing agent slurry to adjust a pH value of the used polishing agent slurry at 25° C. equivalent to be 8.0 or more; and

after the first process, a second process of preparing a recycled polishing agent slurry from the polishing agent component by separating the polishing agent component and the constituent component of an object to be polished.

From the viewpoint of effectively recycling the polishing agent slurry, it is preferable that the second process contains: a separation and concentration process of separating the polishing agent component and the constituent component of the object to be polished by natural sedimentation, centrifugation, sedimentation by adding salt, filter filtration, or agglomeration precipitation by pH value adjustment; and a polishing agent recycle process of preparing a recycled polishing agent slurry from the separated and concentrated polishing agent component.

Further, in the desalting process, desalting is performed so that the ion concentration of the used polishing agent slurry becomes 0.1 mS/cm or less as an electrical conductivity value at 25° C. equivalent. This is preferable from the viewpoint of efficiently performing the dispersion treatment process of adding only the pH adjusting agent to the polishing agent slurry and dispersing the polishing agent component and the constituent component of the object to be polished.

Further, in the second process, the coagulation sedimentation is preferably performed by adjusting the pH value at 25° C. equivalent of the used polishing agent slurry to a range of 6.0 or more and less than 8.0. It is preferable from the viewpoint of improving the separation and concentration rate. An inorganic acid, a carboxylic acid, an amine base, or ammonium hydroxide may be appropriately used as the pH adjusting agent.

The polishing agent slurry recycle system of the present invention removes the constituent component of the object to be polished from the used polishing agent slurry containing the polishing agent component and the constituent component of the object to be polished, and collects and recycles the polishing agent component. This polishing agent slurry recycle system contains the following units: a polishing process unit having a polishing device; a polishing agent slurry supply process unit having a slurry supply tank for supplying the polishing agent slurry to the polishing process unit; a slurry collecting process unit having a collecting mixture liquid tank for collecting the used polishing agent slurry discharged from the polishing device; a desalting treatment process unit having a diluting water supply tank for reducing the ion concentration of the collected polishing agent slurry, a desalting treatment tank, a desalting treatment apparatus, and an ion concentration measuring part for measuring the ion concentration; a dispersion treatment process unit having an additive supply tank for supplying a pH adjusting agent and a dispersing agent to the desalted polishing agent slurry, a dispersion tank for dispersing the polishing agent component and the constituent component of the object to be polished, and a dispersion treatment device; a separation and concentration process unit having a separation and concentration tank that separates and concentrates the polishing agent component and the constituent component of the object to be polished; and a polishing agent recycle process unit having a polishing agent slurry preparation tank having an additive supply tank for adding a pH adjusting agent and a dispersing agent to the separated and concentrated polishing agent component.

It is preferable that the separation and concentration process unit has a natural sedimentation device, a centrifugal separation device, a device for sedimentation and separation by adding a salt, a filter filtration device, or an agglomeration precipitation device by pH value adjustment from the viewpoint of performing efficient separation and concentration.

Hereinafter, the present invention, its constituent elements, and configurations and embodiments for carrying out the present invention will be described in detail. In the present application, “to” is used to mean that the numerical values described before and after “to” are included as the lower limit value and the upper limit value.

Further, in the present invention, the “used polishing agent slurry” is a polishing agent slurry that is a target in the recycle of the polishing agent slurry. It refers to a newly prepared polishing agent slurry or a polishing agent slurry that has been collected and recycled after being polished using a recycled polishing agent slurry. Therefore, it is a polishing agent slurry that is a target when determining the removal rate of the glass component according to the present invention. Hereinafter, the recycle method of the polishing agent slurry and the recycle system of the polishing agent slurry will be described in detail.

### <Outline of the Method for Recycling the Polishing Agent Slurry of the Present Invention>

The method for recycling the polishing agent slurry of the present invention is a method for recycling a polishing agent slurry to remove a constituent component of an object to be polished from a used polishing agent slurry containing a polishing agent component and a constituent component of an object to be polished; and to collect and recycle the polishing agent component. This recycling method contains: a first process including a slurry collecting process of collecting the used polishing agent slurry discharged from a polishing device; a desalting treatment process of reducing an ion concentration of the collected polishing agent slurry; and a dispersion treatment process of dispersing the polishing agent component and the constituent component of the object to be polished by adding a pH adjusting agent and a dispersing agent to the desalted polishing agent slurry; and after the first process, a second process of preparing a recycled polishing agent slurry from the polishing agent component by separating the polishing agent component and the constituent component of the object to be polished.

As described above, in order to increase the utilization efficiency of abrasive grains containing cerium oxide (glass processing amount per abrasive mass), when polishing is performed for as long as possible, the used polishing agent slurry will contain a large amount of polished glass components, an ionic component derived from glass, and ionic component derived from the pH adjusting agent. The glass component itself tends to have a gelled structure, and the polishing agent particles and the glass component form aggregates, so that even if a known technique is applied, it was difficult to separate the polishing agent particles and the glass component.

In an example of such a used polishing agent slurry, the glass component may be 3.3 g/L or more, and the ion concentration may be 5.0 mS/cm or more as an electrical conductivity value at 25° C. equivalent. The load applied to the recycle treatment was significantly different from that of the conventionally known used polishing agent slurry having a glass component of about 1.0 g/L and an ion concentration of about 1.4 mS/cm. As a result, the frequency of poor reproduction was high.

However, the present invention uses a recycle method of a polishing agent slurry containing the first process and the second process as described above. When performing a polishing agent recycle process for removing a constituent component of an object to be polished (glass component) from a used polishing agent slurry containing a large amount of polished glass component, an ionic component derived from glass, and an ionic component derived from a pH adjusting agent, the present invention may provide a method for recycling a polishing agent slurry having excellent separability between an abrasive grain component containing cerium oxide and a component (glass component) of an object to be polished, and the present invention may provide a system for recycling a polishing agent slurry.

In addition, in the used polishing agent slurry containing the conventional glass component concentration and ionic component concentration, by utilizing the features of the recycle method of the present invention, it is possible to provide a method for recycling a polishing agent slurry having excellent separability between an abrasive grain component containing cerium oxide and a component (glass component) of an object to be polished.

From the viewpoint of efficiently performing the polishing agent slurry recycle method, the polishing agent slurry recycle system of the present invention contains the following units: a polishing process unit having a polishing device; a polishing agent slurry supply process unit having a slurry supply tank for supplying the polishing agent slurry to the polishing process unit; a slurry collecting process unit having a collecting mixture liquid tank for collecting the used polishing agent slurry discharged from the polishing device; a desalting treatment process unit having a diluting water supply tank for reducing the ion concentration of the collected polishing agent slurry, a desalting treatment tank, a desalting treatment apparatus, and an ion concentration measuring part for measuring the ion concentration; a dispersion treatment process unit having an additive supply tank for supplying a pH adjusting agent and a dispersing agent to the desalted polishing agent slurry, a dispersion tank for dispersing the polishing agent component and the constituent component of the object to be polished, and a dispersion treatment device; a separation and concentration process unit having a separation and concentration tank that separates and concentrates the polishing agent component and the constituent component of the object to be polished; and a polishing agent recycle process unit having a polishing agent slurry preparation tank having an additive supply tank for adding a pH adjusting agent and a dispersing agent to the separated and concentrated polishing agent component.

It is preferable that the separation and concentration process unit has a natural sedimentation device, a centrifugal separation device, a device for sedimentation and separation by adding a salt, or a filter filtration device from the viewpoint of performing efficient separation and concentration.

As an alternative method for recycling polishing agent slurry of the present invention, the following embodiment is preferably adopted.

A method for recycling a polishing agent slurry to remove a constituent component of an object to be polished from a used polishing agent slurry containing a polishing agent component and the constituent component of the object to be polished, and to collect and recycle the polishing agent component, the method comprising:

a first process including: a slurry collecting process of collecting the used polishing agent slurry discharged from a polishing device;

a desalting treatment process of adjusting an ion concentration of the collected polishing agent slurry to be 0.3 mS/cm or less as an electrical conductivity value at 25° C. equivalent; and

a dispersion treatment process of dispersing the polishing agent component and the constituent component of the object to be polished by adding a pH adjusting agent to the desalted polishing agent slurry to adjust a pH value of the used polishing agent slurry at 25° C. equivalent to be 8.0 or more; and

after the first process, a second process of preparing a recycled polishing agent slurry from the polishing agent component by separating the polishing agent component and the constituent component of an object to be polished.

Further, in the second process, it is preferable that the separating and concentrating treatment of the polishing agent component and the constituent component of the object to be polished is done by adopting agglomeration precipitation by pH value adjustment, in addition to natural sedimentation, centrifugation, sedimentation by adding salt, and filter filtration. This is preferable from the viewpoint of improving the rate of the separation and concentration process and performing the separation and concentration efficiently.

When using this alternative method, in the desalting treatment process, desalting is performed so that the ion concentration of the used polishing agent slurry becomes 0.1 mS/cm or less as an electrical conductivity value at 25° C. equivalent. This desalting treatment is preferable from the viewpoint of efficiently performing the dispersion treatment process by adding only the pH adjusting agent to the polishing agent slurry and dispersing the polishing agent component and the constituent component of the object to be polished.

In that case, the pH value adjustment in the second process may be performed by adjusting the pH value at 25° C. equivalent of the used polishing agent slurry in the range of 6.0 or more and less than 8.0. This is a preferred embodiment.

Hereinafter, the method for recycling the polishing agent slurry of the present invention will be described mainly along the process flow, but a method of recycling the polishing agent slurry by the above alternative method and the recycle system will also be referred to as appropriate. However, this is an example, and the present invention is not limited to this description.

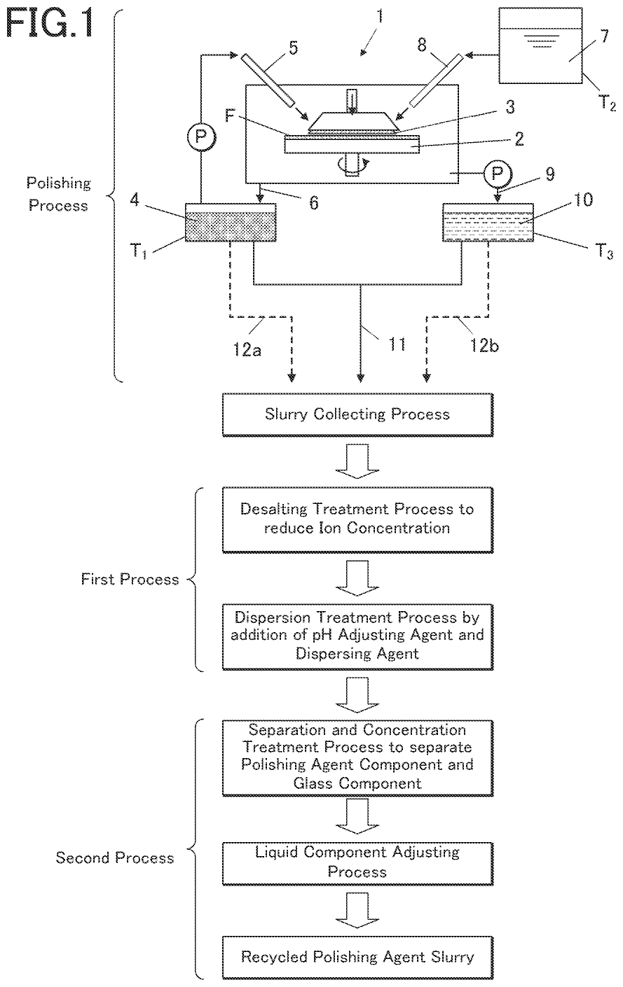

FIG. 1 is a schematic diagram showing an example of a basic process flow of a method for recycling a polishing agent slurry of the present embodiment.

### [1] Polishing Process

### [Polishing Agent]

Generally used polishing agents for optical glass or semiconductor substrate include fine particles of Bengala (αFe₂O₃), cerium oxide, aluminum oxide, manganese oxide, zirconium oxide, or colloidal silica, dispersed in water or oil and made into a slurry. In the present invention, in order to obtain a sufficient processing rate while maintaining high precision flatness in the polishing process of the surface of semiconductor substrates and glass, a polishing agent having cerium oxide as a main component suitable for chemical mechanical polishing (CMP) processing is used, which polishes by both physical and chemical actions.

Cerium oxide used as the polishing agent may be high-purity cerium oxide (made by, C.I. Kasei Co., Ltd., Chemicals, Techno Rise Corporation, Wako Pure Chemical Industries, Ltd.), which has almost 100% of cerium oxide content, and may not be a pure cerium oxide manufactured by calcination of bastnaesite, that is an ore containing rare earth elements other than cerium, and then it is grinded. Rare earth elements such as lanthanum, neodymium, and praseodymium may be included as rare earth components, and besides oxides, fluorides may also be included.

In the present invention, cerium oxide polishing agents that are generally available on the market may be used regardless of their composition and shape. In particular, polishing agents with a cerium oxide content of 50% by mass or more are highly effective and preferred.

### [Polishing]

The polishing contains the following using form (polishing process). The object to be polished may be a silicon-based material, such as optical glass, a glass substrate for information storage medium, cover glass for smartphones, an in-vehicle display, and a silicon wafer. A polishing process of a glass substrate usually includes a series of processes, for example, preparation of the polishing agent slurry, polishing process, and washing, as illustrated in FIG. 1.

The unused polishing agent slurry is preferably prepared by using a powder of a polishing agent containing cerium oxide as a main component and a dispersing agent, and the content of the abrasive is made to be 0.1 to 40% by mass with respect to a solvent such as water. As the cerium oxide fine particles used as the polishing agent, particles having an average particle size (particle size (D50)) of several tens of nm to several μm are used.

In the present invention, agglomeration of cerium oxide particles is prevented by adding the dispersing agent. Furthermore, by constantly stirring using a stirrer, the cerium oxide particles are prevented from sedimentation and maintain their dispersion state. In a generally and preferably adopted method, a tank for the polishing agent slurry is placed next to a polishing device, the dispersion state is maintained by using a stirrer, and a supply pump is used for circulating supply to the polishing device.

The polishing agent slurry is preferably an unused polishing agent slurry, but it may also be a recycled polishing agent slurry. That is, the recycled polishing agent slurry may be newly prepared as an unused polishing agent slurry depending on the purpose and application, and it may be used as an unused polishing agent slurry.

For example, a used polishing agent slurry that has been used in the polishing process of quartz glass may be collected to prepare a recycled polishing agent slurry in accordance with the present invention, which may in turn be used as an unused polishing agent slurry for polishing aluminosilicate glass by adding a different additive appropriate for the unused polishing agent slurry for polishing aluminosilicate glass. Such a recycled polishing agent slurry may be used as an unused polishing agent slurry to further prepare a recycled polishing agent slurry for polishing aluminosilicate glass in accordance with the present invention.

A new slurry is prepared as an unused polishing agent slurry in this way when the object to be polished is different as described above, or when the polishing process of a single product involves multiple polishing processes such as a rough polishing process and a precision polishing process. Additives to be added to the newly prepared unused polishing agent slurry include a pH adjusting agent or a dispersing agent described later.

In the polishing process illustrated in FIG. 1, a polishing device 1 (polishing apparatus) has a rotatable polishing surface plate 2 to which a polishing cloth F made of non-woven fabric, synthetic resin foam, or synthetic leather is attached. During polishing operation, the polishing surface plate 2 rotates while the object to be polished (for example, glass) 3 is pressed against the polishing surface plate 2 with a predetermined pressing force. At the same time, a polishing agent liquid 4 containing cerium oxide is supplied from the slurry nozzle 5 via a pump. The polishing agent liquid 4 containing cerium oxide is stored in a slurry tank T₁ (slurry supply tank) through a flow path 6, and is repeatedly circulated through the polishing device 1 and the slurry tank T₁.

Washing water 7 for washing the polishing device 1 is stored in a washing water storage tank T₂, and is sprayed from the washing water jet nozzle 8 onto the polishing portion for washing. The washing liquid 10 containing the polishing agent is stored in the washing liquid storage tank T₃ via a pump and through a flow path 9. This washing liquid storage tank T₃ is used to store the washing water after being used for washing (rinsing). In order to prevent precipitation and agglomeration, the washing liquid is constantly stirred by a stirrer blade.

Both the polishing agent liquid 4 that is circulated and used during the polishing process and stored in the slurry tank T₁ (used polishing agent slurry a, to be described later) and the washing liquid 10 that is stored in the washing liquid storage tank T₃ and includes the polishing agent (used polishing agent slurry b, to be described later) include non-polishing agents that are scraped from the polished material (for example, glass) 3 that has been polished in the polishing process 1, as well as cerium oxide particles as the polishing agent.

### [2] First Process

The first process in the present invention includes: a slurry collecting process of collecting the used polishing agent slurry discharged from the polishing device; a desalting treatment process of reducing the ion concentration of the collected polishing agent slurry; and a dispersion treatment process of dispersing the polishing agent component and the constituent component of the object to be polished by adding a pH adjusting agent and a dispersing agent to the desalted polishing agent slurry. Each process will be described in the following.

### [2.1] Slurry Collecting Process

Next, the polishing agent liquid 4 and the washing liquid 10 including the polishing agent are collected, either as a mixed liquid or as separate liquids. This process is referred to as a slurry collecting process.

The used polishing agent slurry, referred to in the present invention is a polishing agent slurry discharged to the outside of a system including a polishing device and a tank for a polishing agent slurry, and there are mainly two types shown below.

The first one is the polishing agent slurry a (rinse slurry) that contains the washing liquid drained during the washing process, and the second one is the used polishing agent slurry b (life end) stored in the slurry tank T₁ that is discarded after a certain number of times of use. In the present invention, they are referred to respectively as the polishing agent slurry a and the polishing agent slurry b. The present invention is preferably applied to both of the polishing agent slurries a and b, but may be applied to only one of them.

The polishing agent slurry a that includes washing water is characterized by the following two points.

(1) Since the polishing agent slurry a is drained during washing with a large amount of washing water, the concentration of the polishing agent is lower than that of the slurry in the tank.
(2) Glass components adhering to the polishing cloth also flow into this polishing agent slurry a during washing.

On the other hand, the used polishing agent slurry b is characterized by a higher concentration of the polished material component compared to the polishing agent slurry before use.

Immediately after the polishing, a large amount of polishing agent adheres to the glass substrate and the polishing device. Therefore, as illustrated in FIG. 1, water is supplied instead of the polishing agent slurry after polishing in order to wash the polishing agent adhered to the glass substrate and polishing device. At this time, the washing liquid containing the polishing agent is drained out of the system.

Generally, the collected polishing agent slurry includes cerium oxide polishing agent in the range of 0.01 to 40% by mass. However, since a certain amount of polishing agent is drained out of the system during this washing operation, the amount of polishing agent in the system is decreased. To compensate for this decrease, a new polishing agent slurry may be added to the slurry tank T₁. The addition may be done for each time of the processing or for every certain amount of processing, but in any case, it is desirable to supply the polishing agent that is well dispersed in the solvent.

Next, in order to recycle the polishing agent slurry from the used polishing agent slurry, it is required a separation and concentration process to a mixed solution of the polishing agent liquid 4 collected in the slurry collecting process and the washing liquid 10 containing the polishing agent, or each individual liquid (hereinafter, these solutions are sometimes referred to as a “mother liquid”) so that only the polishing agent is separated from the mother liquid and concentrated without aggregating the object to be polished (for example, a glass component). As described above, in a used polishing agent slurry containing a large amount of glass components, an ionic component derived from glass, and ionic component derived from the pH adjusting agent, it is easy that the glass component itself will take a gelled structure. Further, when the polishing agent particles and the glass component have formed an agglomerate, it is difficult to separate the polishing agent particles and the glass component even if the above-mentioned known technique is applied.

Therefore, in the present invention, after performing the slurry collecting process of collecting the used polishing agent slurry discharged from the polishing device, the following new processes were adopted: a desalting treatment process of reducing the ion concentration of the collected polishing agent slurry; and a dispersion treatment process of dispersing the polishing agent component and the constituent component of the object to be polished by adding a pH adjusting agent and a dispersing agent to the desalted polishing agent slurry. This series of processes is called a first process.

In the first process according to the present invention, it is preferable to carry out a process of removing coarse foreign matter in advance (also referred to as a “foreign matter removing process”) by a filter filtration method using a filter for the collected polishing agent slurry before the desalting treatment process. In this case, in order to remove foreign matter, it is preferable to filter by a filter having a pore size of 20 to 100 μm alone or by using filters having different pore diameters in multiple stages. As an example of multi-stage filtration, it is preferable to use a filter having a diameter of 25 μm and a filter having a diameter of 10 μm in combination and continuously.

The filtration filter used for filtration is not particularly limited, and examples thereof include a membrane filter, a hollow fiber filter, a metal filter, a thread winding filter, a ceramic filter, and a roll-type polypropylene filter.

Preferably applied ceramic filters include, for example, ceramic filters manufactured by TAMI Industries in France, Ceramic filters manufactured by Noritake. Co., Ltd., Japan, ceramic filters manufactured by NGK Insulators, Ltd. (for example, SERA LEC DPF, and CEFILT), and ceramic filters manufactured by Pall Corporation.

### [2.2] Desalting Treatment Process

The filtered polishing agent slurry is first processed in the desalting treatment process.

The desalting treatment process is a process of removing or reducing the concentration of dissolved glass, an ionic component derived from the glass, an ionic component derived from a pH adjusting agent.

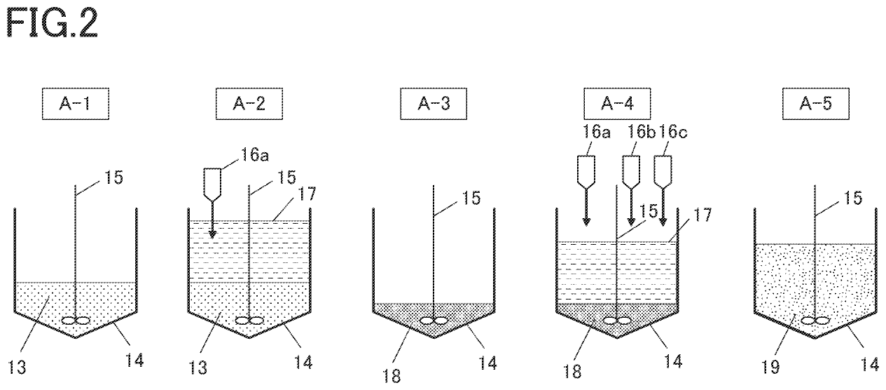

FIG. 2 is a schematic diagram showing an example of a first process flow.

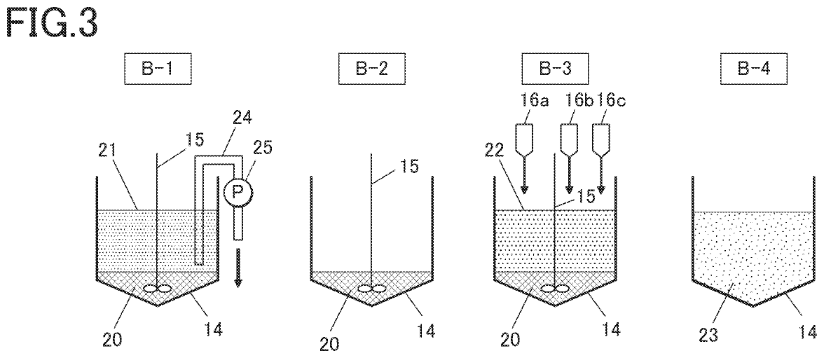

As Step (A-1), the used polishing agent slurry (also referred to as “mother liquid”) 13 collected in the slurry collecting process which is the previous process is filtered to remove foreign substances, and then, it is put in an adjustment kettle 14 provided with a stirrer 15 (FIG. 2 and FIG. 3 show an example in which the adjustment kettle 14 also serves as a collecting mixture liquid tank, a desalting treatment tank, a dispersion tank, a separation and concentration tank, and a preparation tank for a recycled polishing agent slurry). Next, in Step (A-2), while stirring the polishing agent slurry (mother liquid) 13, diluting water 17 is added from a diluting water tank 16a (diluting water supply tank) so that an electrical conductivity value at 25° C. equivalent is preferably 5.0 mS/cm or less, more preferably 1.0 mS/cm or less. Distilled water, purified water, ion-exchanged water, or pure water may be used as the diluting water, but pure water having an ion content reduced as much as possible is preferable. The adjustment kettle 14 has an ion concentration measuring part (not shown) to monitor the electrical conductivity value.

The process of adding the diluting water may be performed once, or the diluting water is added to form a uniform slurry by stirring, filtered by the above-mentioned filtration filter, and then further diluting water is added to decrease the electrical conductivity value of the polishing agent slurry.

The amount of diluting water added may be appropriately adjusted by setting the ion concentration of the used polishing agent slurry, but it may be in the range of 2 to 10 times the volume of the used polishing agent slurry.

The electrical conductivity value may be determined by measuring from a sample liquid warmed to 25° C. by using, for example, Electrical conductivity meter ES-51 (manufactured by HORIBA, Ltd.), Electrical conductivity meter CM-30G (manufactured by DKK-TOA CORPORATION), Lacom tester handheld electrical conductivity meter CyberScan CON 110 (manufactured by AS One Corporation), and Compact electrical conductivity meter LAQUAtwin B-771 (manufactured by HORIBA, Ltd.).

In Step (A-3), after diluting and adjusting the electrical conductivity value at 25° C. equivalent of the polishing agent slurry 13 to a desired value or less, cerium oxide is subjected to the above-mentioned filter filtration method using a filtration filter. By filtering with a filter having a pore size smaller than that of the above particles, solid-liquid separation is performed to obtain a mixture 18 of an abrasive grain component containing cerium oxide and a glass component. Further, it may be divided into a precipitation portion containing cerium oxide and a supernatant portion in which an ionic component is dissolved by natural sedimentation.

When the alternative method is adopted as the method for recycling the polishing agent slurry, in Step (A-2), while stirring the abrasive slurry (mother liquor) 13, diluting water 17 is added from the diluting water tank 16a (diluting water supply tank) so that the electrical conductivity value at 25° C. equivalent is 0.3 mS/cm or less, more preferably 0.1 mS/cm or less.

The abrasive grain component containing cerium oxide contained in the used polishing agent slurry and the glass component constituting the object to be polished tend to aggregate in the slurry due to the influence of the ion components contained in the slurry. Therefore, it is preferable to reduce the ionic component in advance from the viewpoint of efficiently performing the dispersion treatment, which is the next process.

### [2.3] Dispersion Treatment Process

The dispersion treatment process is a process of separating abrasive grains containing cerium oxide and the glass component adhering to the abrasive grains by adjusting the pH value and adding a dispersing agent.

In Step (A-4), water is added from the diluting water tank 16a to disperse the mixture, and then the pH value at 25° C. equivalent is adjusted to a range of 6.0 to 10.5 by the pH adjusting agent supply tank 16b. Next, from the dispersing agent supply tank 16c, it is preferable to add the dispersing agent in the range of 0.1 to 5.0% by mass with respect to the mass of the polishing agent contained in the used polishing agent slurry. By adjusting the pH value, addition of a dispersing agent, and use a dispersion treatment device such as a stirrer 15, it is possible to disperse the abrasive grain component containing cerium oxide and the glass component to the extent that they may be easily separated. In Step (A-5), a polishing agent slurry which is a dispersion 19 containing an abrasive grain component containing cerium oxide and a glass component is obtained.

It is preferable to add the pH adjusting agent and the dispersing agent so that the surface potentials of the abrasive grain component containing cerium oxide and the glass component contained in the slurry are in phase with each other. In the dispersion treatment, it is more preferable to apply energy by an ultrasonic disperser, which will be described later, in addition to stirring.

When adopting the above alternative method for recycling the polishing agent slurry, in Step (A-4), water is added to the mixture from the diluting water tank 16a to disperse it in water, and then by using the pH adjusting agent supply tank 16b, the pH value at 25° C. equivalent is adjusted to a range of 8.0 to 10.5. In this case, it is necessary to adjust the pH value to 8.0 or higher from the viewpoint of efficiently performing the dispersion treatment.

### <pH Adjusting Agent>

Acids or alkalis added as the pH adjusting agent are not particularly limited, and may be inorganic acids or organic acids. However, when polishing materials such as silicon oxide layers that are used in the semiconductor field, it is preferable to use a pH adjusting agent that does not contain metallic elements. The pH adjusting agent is preferably an inorganic acid, carboxylic acid, amine base, or ammonium hydroxide. It is preferable from the viewpoint of suppressing contamination of unnecessary extra metal ions in the polishing process.

The pH value used here is the value measured at 25° C. using a Lacom tester tabletop-type pH meter (pH 1500 manufactured by As One Corporation).

### <Dispersing Agent>

Examples of the dispersing agent include a water-soluble anionic dispersing agent, a water-soluble cationic dispersing agent, and a water-soluble amphoteric dispersing agent. Examples of the preferred dispersing agent also include ammonium polyacrylate, a copolymer of acrylamide and ammonium acrylate, and an acrylic acid maleic acid copolymer.

Two or more dispersing agents may be used together, including at least one polymeric dispersing agent containing ammonium acrylate salt as a copolymer component and at least one selected from a water-soluble anionic dispersing agent, a water-soluble cationic dispersing agent, or a water-soluble amphoteric dispersing agent.

Among these, examples of the dispersing agent preferably used in the present invention include a water-soluble anionic dispersing agent, a water-soluble cationic dispersing agent, and a water-soluble amphoteric dispersing agent, from the viewpoint of measuring and controlling the amount of the dispersing agent in the recycled polishing agent slurry based on an electrical conductivity value as an indicator.

For use in polishing in the manufacture of semiconductor devices, the content of metal elements such as sodium ions and potassium ions in the dispersing agent is preferably suppressed at 10 ppm or less.

### (Water-Soluble Anionic Dispersing Agent)

Examples of the anionic dispersing agent include triethanolamine lauryl sulfate, ammonium lauryl sulfate, triethanolamine polyoxyethylene alkyl ether sulfate, and a polycarboxylic acid type polymer dispersing agent.

Examples of the polycarboxylic acid type polymer dispersing agent include a polymer of a carboxylic acid monomer having an unsaturated double bond such as acrylic acid, methacrylic acid, maleic acid, fumaric acid, or itaconic acid, a copolymer of a carboxylic acid monomer having an unsaturated double bond and another monomer having an unsaturated double bond, and their ammonium salts, and amine salts.

### (Water-Soluble Cationic Dispersing Agent)

Examples of the cationic dispersing agent include primary to tertiary aliphatic amines, quaternary ammonium, tetraalkylammonium, trialkylbenzylammonium alkylpyridinium, 2-alkyl-1-alkyl hydroxyethylimidazolinium, N,N-dialkylmorpholinium, polyethylene polyamine fatty acid amides, urea condensates of polyethylene polyamine fatty acid amides, quaternary ammonium of urea condensates of polyethylene polyamine fatty acid amides, and salts thereof

### (Water-Soluble Amphoteric Dispersing Agent)

Betaine dispersing agents are preferred as the water-soluble amphoteric dispersing agents. The betaine dispersing agents include, for example, betaines such as N,N-dimethyl-N-alkyl-N-carboxymethylammonium betaine, N,N,N-trialkyl-N-sulfoalkyl ammonium betaine, N,N-dialkyl-N,N-bis-polyoxyethylene ammonium sulfate betaine, 2-alkyl-1-carboxymethyl-1-hydroxyethylimidazolinium betaine; and aminocarboxylic acids such as N,N-dialkylaminoalkylene carboxylates.

### (Addition Amount of Dispersing Agent)

The addition amount of the dispersing agent is preferably in the range of 0.01 to 5.0 parts by mass with respect to 100 parts by mass of cerium oxide particles based on the relationship between the dispersing ability and prevention of sedimentation of the polishing agent particles in the polishing agent slurry, polishing scratches, and the addition amount of the dispersing agent. The molecular weight of the dispersing agent is preferably in the range of 100 to 50000, and more preferably in the range of 1000 to 10000. When the molecular weight of the dispersing agent is 100 or more, enough polishing rate may be achieved. When the molecular weight of the dispersing agent is 50000 or less, the increase in viscosity may be suppressed and the storage stability of the CMP polishing agent may be ensured.

As a method of dispersing these polishing agent particles in water, a homogenizer, an ultrasonic dispersing machine, or a wet ball mill, may be used as well as the usual dispersion treatment process using a stirrer.

### [3] Second Process

The second process contains: a separation and concentration process of separating the polishing agent component and the constituent component of the object to be polished by natural sedimentation, centrifugation, sedimentation separation by adding a salt, filter filtration, or agglomeration precipitation by pH value adjustment; and a polishing agent recycle process of preparing a recycled polishing agent slurry from the separated and concentrated polishing agent component. FIG. 3 is a schematic view showing a second process flow. Individual devices for natural sedimentation, centrifugation, salt-added sedimentation, or filter filtration in the separation and concentration process are not shown.

### [3.1] Separation and Concentration Process

Step (B-1) and Step (B-2) of FIG. 3 each are a schematic view illustrating a process of separating and concentrating the polishing agent from the polishing agent slurry dispersed and concentrated in the first process.

In the separation and concentration process, natural sedimentation, centrifugation, sedimentation separation by adding a salt, filter filtration, or agglomeration precipitation by pH value adjustment may be appropriately used. The natural sedimentation method is preferable, but when the above-described alternative method is employed, it is also preferable to appropriately use the agglomeration precipitation method by adjusting the pH value.

In Step (B-1) of FIG. 3, the polishing agent slurry dispersed in the first process is then subjected to precipitation. The abrasive grain component containing cerium oxide is precipitated by the natural sedimentation method, utilizing the density difference and size difference between the abrasive grain component containing cerium oxide and the glass component. After that, the supernatant liquid 21 containing the glass component is discharged by a supernatant liquid discharge pipe 24 and a pump 25, and the abrasive grain component 20 containing cerium oxide separated from the glass component is concentrated in Step (B-2).

When adopting the above alternative method for recycling the polishing agent slurry, in Step (B-1), water is added to the mixture from the diluting water tank 16a to disperse the mixture. By adjusting the pH value at 25° C. equivalent in the range of 6.0 or more and less than 8.0 with the pH adjusting agent supply tank 16b, the abrasive grain component containing cerium oxide is aggregated and precipitated, and the separation and concentration process is efficiently performed.

By returning the pH value of the used polishing agent slurry in the dispersed state to near neutral, the surface potential of the abrasive grain component containing cerium oxide approaches zero (isoelectric point). Therefore, the electrostatic repulsive force is lowered, and the abrasive grain component containing the cerium oxide is selectively aggregated again.

That is, by adjusting the pH value, the abrasive grain component containing cerium oxide is selectively aggregated again, thereby increasing the sedimentation rate and making it possible to improve the processing rate of the separation and concentration process.

Compared to the case of natural sedimentation, since the glass component enters inside the agglomerate of the abrasive grain component containing cerium oxide, it is slightly disadvantageous to natural sedimentation from the viewpoint of the removal rate of the glass component. However, since the natural sedimentation rate of the cerium oxide particles is very slow, particularly in a polishing agent slurry with a small cerium oxide particle size, it is practically advantageous to increase the sedimentation rate by intentionally aggregating the cerium oxide particles.

In the separation and concentration process, an agglomeration precipitation method may also be used as long as the effects of the present invention are not impaired. Hereinafter, the agglomeration precipitation method that may be used will be described.

### <Agglomeration Precipitation Method>

In the agglomeration precipitation method, a divalent alkaline earth metal salt or a monovalent alkaline metal salt as an inorganic salt is added to the polishing agent slurry subjected to the dispersion treatment process, and the cerium oxide polishing agent is separated from the component derived from the polished material and is concentrated.

Specifically, a divalent alkaline earth metal salt as an inorganic salt is preferably added to the dispersed polishing agent slurry at a pH value at 25° C. equivalent in the range of 6.5 or more and less than 10.0, and the cerium oxide polishing agent is preferably separated from the component derived from the polished material and concentrated. By doing so, only the polishing agent component, which is mainly cerium oxide, is agglomerated and precipitated, and then the agglomerate is separated from the glass component, which is mostly present in the supernatant. This makes it possible to separate the cerium oxide component from the glass component and to concentrate the polishing agent slurry at the same time. The alkaline earth metal salt is used as the agglomerating agent to selectively agglomerate and precipitate the cerium oxide contained in the used polishing agent slurry.

The pH adjusting agent used for adjusting the pH value may be the same as the pH adjusting agent described above.

### (Divalent Alkaline Earth Metal Salt)

In the present invention, the inorganic salt used for agglomeration of cerium oxide is preferably a divalent alkaline earth metal salt.

The divalent alkaline earth metal salts related to the present invention include, for example, calcium salts, barium salts, beryllium salts, and magnesium salts. Among them, from the viewpoint of being able to better express the effects of the present invention, the divalent alkaline earth metal salt is preferably a magnesium salt.

Magnesium salts applicable to the present invention are not limited as long as they function as electrolytes, but magnesium chloride, magnesium bromide, magnesium iodide, magnesium sulfate, and magnesium acetate are preferred because of their high solubility in water. Magnesium chloride and magnesium sulfate are particularly preferred because of the small pH change of the solution and the easy treatment of sediment of the polishing agent and waste solution.

### (Addition Method of Divalent Alkaline Earth Metal Salt)

In the following, a method of adding magnesium salts, which are divalent alkaline earth metal salts, is described.

### (a) Concentration of Magnesium Salt

The magnesium salt to be added may be supplied as a powder directly to the collected slurry or dissolved in a solvent such as water before being added to the polishing agent slurry. In either case, the magnesium salt is preferably added to the polishing agent slurry in a state dissolved in a solvent so as to be uniform in the slurry.

The concentration of the aqueous solution is preferably 0.5 to 50% by mass. In order to reduce pH variation in the system and to improve the efficiency of separation from the glass component, it is more preferably from 1 to 10% by mass.

### (b) Temperature During Addition of Magnesium Salt

The temperature at which the magnesium salt is added may be appropriately selected from above the temperature at which the collected polishing agent slurry freezes and 90° C. However, from the viewpoint of effective separation from the glass component, the temperature is preferably in the range of 10 to 40° C., and more preferably in the range of 15 to 35° C.

### (c) Addition Rate of Magnesium Salt

The magnesium salt is preferably added at a rate that ensures that the magnesium concentration in the collected polishing agent slurry does not become locally high but is uniform. The amount of magnesium salt added per minute is preferably 20% by mass or less of the total amount to be added, and more preferably 10% by mass or less of the total amount to be added.

### (d) pH Value During Addition of Magnesium Salt

In the separation and concentration process, separation and concentration are preferably performed by adding the magnesium salt, at a pH value at 25° C. equivalent of the mother liquid of 6.5 or more and less than 10.0.

(e) Stirring after Magnesium Salt Addition

After adding the magnesium salt, it is preferable to continue stirring for at least 10 minutes, and more preferably for at least 30 minutes. Although agglomeration of polishing agent particles starts as soon as the magnesium salt is added, continuing stirring makes the agglomeration state uniform throughout the system and the particle size distribution of the agglomerates narrower, thereby allowing for easy separation afterwards.

Concentration is carried out so that the polishing agent concentration becomes a desired concentration in the range of 0.1 to 40% by mass.

By setting the polishing agent concentration to 0.1% by mass or more, an polishing agent having high polishing performance may be obtained, and by setting it to 40% by mass or less, a polishing agent slurry having an appropriate concentration may be recycled without clogging the filter.

### [3.2] Polishing Agent Slurry Recycle Process

In Step (B-3) of FIG. 3, to the abrasive grain component containing cerium oxide separated and concentrated by the separation and concentration process is added with water from the diluting water tank 16a, and if required, are added with a pH adjusting agent from a pH adjusting agent supply tank 16b and a dispersing agent from a dispersing agent supply tank 16c. Thereby, component adjustment of the recycled polishing agent is performed. The addition of pH adjusting agent and dispersing agent is not essential and may be omitted. By adding a pH adjusting agent that interacts with components such as the component to be polished mixed in the recycled polishing agent slurry in the separated and concentrated polishing agent slurry containing cerium oxide, the ionic component eluted from the component to be polished, or the metal ion mixed in the processes from use as a polishing agent to collection, it is possible to adjust the pH value at 25° C. equivalent in the range of 6.0 to 10.5, and the electrical conductivity value may be adjusted. The recycled polishing agent slurry 23 is obtained in Step (B-4).

In addition, when the cerium oxide particles form aggregates (secondary particles) in the concentrate containing concentrated cerium oxide, in order to loosen them up to a state close to an independent primary particle, it is preferable to add a dispersing agent and a pH adjusting agent and then disperse to a desired particle size using a dispersing agent to control the particle size in the polishing agent recycle process.

By adding the pH adjusting agent and the dispersing agent in this way, it is possible that the pH value of the recycled polishing agent slurry and the electrical conductivity value of the recycled polishing agent slurry containing the dispersing agent are equal to or similar to those of the unused polishing agent slurry. It is possible to reduce the decrease in polishing rate and the variation in quality.

A recycled polishing agent slurry may be prepared using an unused polishing agent slurry, and after polishing using the recycled polishing agent slurry, a recycled polishing agent slurry is further prepared from the collected polishing agent slurry according to the present invention. Although it is possible to recycle the polishing agent slurry a plurality of times in this way, the pH value and the electric conductivity value of the recycled polishing agent slurry prepared each time are preferably adjusted for the unused polishing agent slurry.

Specific examples of various component adjustments are shown below.

### <Adjustment of Electrical Conductivity Value and pH Value>

The amount of the dispersing agent to be filled in the concentrated polishing agent slurry prepared in the above Step (B-2) is determined. In the present invention, the fill amount of the dispersing agent is adjusted such that the electrical conductivity value of the recycled polishing agent slurry is 0.10 to 10.00 times with respect to that of the unused polishing agent slurry, and such that the pH value at 25° C. equivalent is in the range of 6.0 to 10.5. More preferably, the pH value is adjusted to a range of 7.0 to 10.0, and even more preferably, it is adjusted to a range of 8.0 to 9.5.

### (Dispersing Agent)

The dispersing agent to be added is preferably the same as that used in the dispersion treatment process. When the content of the dispersing agent is increased, the electrical conductivity increases proportionally. Therefore, the amount of the dispersing agent in the polishing agent slurry may be easily grasped by measuring the electrical conductivity.

The amount of the dispersing agent to be added is adjusted by adjusting the electrical conductivity to be in the above range with respect to the electrical conductivity of the unused polishing agent slurry.

For example, when the unused polishing agent slurry is a recycled polishing agent slurry, it may contain metal ions or other substances that affect electrical conductivity. Therefore, the amount of the dispersing agent to be added needs to be adjusted more than when the unused polishing agent slurry is an unused polishing agent slurry.

The electric conductivity may be measured by adjusting the temperature of the sample liquid to 25° C. using the above-mentioned various electric conductivity meters.

### (pH Adjusting Agent)

Acids or alkalis added as the pH adjusting agent are not particularly limited, and may be inorganic acids or organic acids. However, when polishing materials such as silicon oxide layers that are used in the semiconductor field, it is preferable to use a pH adjusting agent that does not contain metallic elements.

The pH adjusting agent is preferably an inorganic acid, carboxylic acid, amine base, or ammonium hydroxide.

The pH value used here is the value measured at 25° C. using a Lacom tester tabletop-type pH meter (pH 1500 manufactured by As One Corporation).

### (Particle Size Control)

In the polishing agent recycle process, it is desirable to adjust the particle size distribution of cerium oxide particles.

In particular, when cerium oxide particles are collected by agglomerating them using a magnesium salt, it is preferable to re-disperse the agglomerated particles in order to loosen them up. The agglomerated polishing agent component is re-dispersed to adjust the particle size distribution to be equivalent to that of the polishing agent slurry before processing.

The agglomerated polishing agent particles are re-dispersed by using a dispersing machine, to crush the agglomerated polishing agent particles. The dispersing machine may be an ultrasonic dispersing machine, a medium agitating mill such as a sand mill or bead mill, and is particularly preferably an ultrasonic dispersing machine.

Ultrasonic dispersion machines are commercially available from, for example, SMT Corporation, Ginsen Corporation, TAITEC Corporation, BRANSON Corporation, Kinematica AG, and NISSEI Corporation. UDU-1 and UH-600MC (manufactured by SMT Corporation), GSD600CVP (manufactured by Ginsen Corporation), or RUS600TCVP (manufactured by NISSEI Corporation) may be used. The frequency of ultrasonic waves is not particularly limited.

Examples of circulating type machines that perform mechanical stirring and ultrasonic dispersion simultaneously and in parallel include, but are not limited to, UDU-1 and UH-600MC (manufactured by SMT Corporation), GSD600RCVP and GSD1200RCVP (manufactured by Ginsen Corporation), and RUS600TCVP (manufactured by NISSEI Corporation).

### EXAMPLES

Hereinafter, the present invention will be specifically described with reference to examples, but the present invention is not limited to these examples. In the examples, “%” or “part” is used to indicate “% by mass” or “parts by mass” unless otherwise noted. Unless otherwise specified, the polishing agent slurry was basically prepared under the conditions of 25° C. and 55% RH. At this time, the temperature of the solution is also 25° C.

### Example 1

### <Preparation of Used Polishing Agent Slurry 1>

The used polishing agent slurry 1 was prepared according to the following manufacturing process.

### [Preparation of Unused Polishing Agent Slurry 1]

An acrylic acid maleic acid copolymer was added to pure water as a dispersing agent, and the mixture was stirred with a stirrer for 5 minutes. After that, cerium oxide (E21, manufactured by Mitsui Mining & Smelting Co., Ltd.) was added while stirring, and after stirring with a stirrer for 30 minutes, and dispersion was carried out with an ultrasonic dispersing machine (manufactured by BRANSON Corporation).

Cerium oxide was added such that its concentration was 10% by mass, and the dispersing agent was added such that its ratio with respect to cerium oxide was 5% by mass. The unused polishing agent slurry was prepared so that the total volume was 50 L.

After that, the pH value of the prepared unused polishing agent slurry 1 was adjusted to 8.5 using ammonia water as a pH adjusting agent. The electrical conductivity value at 25° C. equivalent was 1.0 mS/cm.

Then, when the average particle size (D50) was measured using a particle size distribution measuring device (for example, LA-950V2, manufactured by HORIBA, Ltd.), the average particle size (D50) was 0.96 μm.

The following measurement devices were used.

pH Value: Lacom tester tabletop-type pH meter (pH 1500, manufactured by As One Corporation)

Electrical conductivity value: Compact electrical conductivity meter LAQUAtwin B-771 (manufactured by HORIBA, Ltd.)

### [Polishing Process]

### <Polishing>

The polishing process of aluminosilicate glass substrate was carried out under the following conditions. The aluminosilicate glass substrate contained 60% by mass of silicon oxide, 15% by mass of oxides of an alkali metal and an alkaline earth metal, and 25% by mass of aluminum oxide and other components.

In the polishing process illustrated in FIG. 1, by using a double-side polishing machine, the unused polishing agent slurry 1 prepared as described above was supplied to a surface to be polished, and the surface to be polished was polished with a polishing cloth. The polishing process was performed while the unused polishing agent slurry 1 was supplied in circulation at a flow rate of 5 L/min. The object to be polished was an aluminosilicate glass substrate with a diameter of 65 mm and a thickness of 5 mm, and the polishing cloth was made of polyurethane. The pressure applied to the surface to be polished during polishing was set to 9.8 kPa (100 g/cm²), and the rotation rate of the polishing testing machine was set at 100 min⁻¹ (rpm), and the polishing process was performed for 30 minutes. The polishing process was performed for 1 batch including 100 pieces of glass substrates.

During the polishing process, the pH was appropriately measured, and if the pH exceeded 8.5, the pH was adjusted to 8.5 or less by adding an aqueous sulfuric acid solution while keeping the pH not below 7.0. Polishing was carried out until the total amount of glass polished was 10 g/L. After the polishing was completed, the cleaning drainage containing the polishing agent slurry and the polishing agent slurry containing the used polishing agent were collected and used as the used polishing agent slurry 1.

The electrical conductivity value at 25° C. equivalent of the used polishing agent slurry 1 was 12.1 mS/cm.

### <Preparation of Recycled Polishing Agent Slurry 1>

### [Separation and Concentration Process]

First, 1.0 L of the collected used polishing agent slurry 1 was filtered using a mesh filter with a pore diameter of 100 μm to remove a coarse foreign matter.

Next, a dispersing agent (ammonium polyacrylate: indicated as PAA in the table) was added in an amount of 2.5% by mass based on the cerium oxide polishing agent particles.

Further, a pH adjusting agent (ammonia water) was added to adjust the pH to 8.5, and then dispersion treatment was performed using an ultrasonic disperser. In the table, the pH adjusting agents are indicated as follows, NH₃: ammonia water, H₂SO₄: sulfuric acid aqueous solution, TEA: triethanolamine, NaOH: sodium hydroxide aqueous solution, and KOH: potassium hydroxide aqueous solution.

After performing the ultrasonic dispersion treatment, the dispersion liquid was allowed to stand for 1 hour, separated into a supernatant and a precipitate by a natural sedimentation method, the supernatant liquid was discharged, and 0.1 L of the polishing agent slurry containing the precipitate was collected. In this way, the glass component was removed and the cerium oxide component was concentrated.

### [Polishing Agent Recycle Process]

### <Adjustment of pH Value and Electrical Conductivity Value>

An acrylic acid maleic acid copolymer as a dispersing agent was added to the above polishing agent slurry. Furthermore, the pH value of the polishing agent slurry was adjusted to 8.5 by using an acetic acid aqueous solution as a pH adjusting agent.

### <Particle Size Control>

Then, after stirring with a stirrer for 30 minutes, the precipitate was dispersed and loosened using an ultrasonic dispersing machine (manufactured by BRANSON Corporation).

After the dispersion was completed, filtration was performed using a depth filter of a pore diameter of 10 μm to obtain recycled polishing agent slurry 1 including cerium oxide.

### <Preparation of Recycled Polishing Agent Slurries 2 to 4>

In the preparation of the recycled polishing agent slurry 1, the recycled polishing agent slurries were prepared under the following conditions.

First, 1.0 L of the used polishing agent slurry 1 was filtered using a mesh filter with a pore diameter of 100 μm to remove a coarse foreign matter.

Next, the filtrate component containing the cerium oxide polishing agent was diluted 3 times (6 times, 10 times) in volume with pure water, and then stirred for 30 minutes using a stirrer. The electrical conductivity value at 25° C. equivalent of the desalted used polishing agent slurry was 5.0 (2.4, 1.4) mS/cm.

After the above stirring treatment, a dispersing agent (ammonium polyacrylate: PAA) was added in an amount of 2.5% by mass based on the cerium oxide polishing agent particles, and a pH adjusting agent (ammonia water) was added to adjust the pH to 8.5. Thereafter, the dispersion treatment was performed using an ultrasonic disperser.

After performing the ultrasonic dispersion treatment, the dispersion liquid was allowed to stand for 1 hour, separated into a supernatant and a precipitate by a natural sedimentation method, the supernatant liquid was discharged, and 0.3 L (0.6 L, 1.0 L) of the polishing agent slurry containing the precipitate was collected. In this way, the glass component was removed and the cerium oxide component was concentrated.

The concentration of the cerium oxide polishing agent and the concentration of the glass component contained in the collected polishing agent slurry were measured by ICP emission spectroscopic plasma method (also referred to as “ICP-AES”). The removal rate of the glass component was measured with respect to the used polishing agent slurry 1.

### (Component Analysis by ICP Emission Spectroscopic Plasma Method)

### <Preparation of Sample Liquid A>

(a) 1 mL of a sample (collected polishing agent slurry) was collected while stirring with a stirrer.
(b) 5 mL of hydrofluoric acid for atomic absorption was added.
(c) Silica was eluted by ultrasonic dispersion.
(d) Allowed to stand at room temperature for 30 minutes.
(e) Finished with ultra-pure water to a total volume of 50 mL.

The sample liquid prepared according to the above procedure is referred to as sample liquid A.

### <Quantification of Cerium Oxide and Glass Component (Si)>

(a) Each sample liquid A was filtered with a membrane filter (hydrophilic PTFE).
(b) The filtrate was measured with an inductively coupled plasma emission spectrophotometer (ICP-AES, manufactured by SII Nanotechnology Inc.).
(c) Cerium oxide and Si were quantified by the calibration curve method of the standard addition method.

The removal rate of the glass component was calculated by the following formula.

[1−(Glass component concentration of recycled polishing agent slurry÷Cerium oxide polishing agent component concentration)÷(Cerium oxide polishing agent component concentration of used polishing agent slurry÷Cerium oxide polishing agent component concentration)]×100(%)

Then, in the same manner as the preparation of the recycled polishing agent slurry 1, the recycled polishing agent slurries 2 to 4 were prepared according to the above-described polishing agent recycle process.

### <Preparation of Recycled Polishing Agent Slurries 5 to 28>

In the preparation of the recycled polishing agent slurry 1, the recycled polishing agent slurries were prepared under the following conditions.

First, 1.0 L of the used polishing agent slurry 1 was filtered using a mesh filter with a pore diameter of 100 inn to remove a coarse foreign matter.

Next, the filtrate component containing the cerium oxide polishing agent was diluted 2 times or 4 times in volume with pure water, and then stirred for 30 minutes using a stirrer.

The agitated polishing agent slurry was filtered through a filter having a pore size of 1.0 μm to collect the solid content remaining on the filter, and then pure water was added to make 20 L, which was dispersed again with a stirrer. However, only the recycled polishing agent slurry 7 was filtered again with a 1.0 μm filter to collect the solid content, and then pure water was added to make 20 L, which was dispersed by a stirrer.

The electrical conductivity values (ion concentrations) at 25° C. equivalent of the desalted used polishing agent slurries are shown in Tables I and II below.

Next, a dispersing agent (ammonium polyacrylate: PAA) was added in an amount of 2.5% by mass based on the cerium oxide polishing agent particles.

Further, a pH adjusting agent (ammonia water) was added to adjust the pH to 8.5, and then dispersion treatment was performed using an ultrasonic disperser.

After performing the ultrasonic dispersion treatment, the dispersion liquid was allowed to stand for 1 hour, separated into a supernatant and a precipitate, and 0.1 L of the polishing agent slurry containing the precipitate was collected.

The concentration of the cerium oxide polishing agent and the concentration of the glass component contained in the collected polishing agent slurry were measured by the above-mentioned method.

Then, in the same manner as the preparation of the recycled polishing agent slurry 1, the recycled polishing agent slurries 5 to 28 were prepared according to the above-described polishing agent recycle process. The types of dispersion agents listed in Table II are as follows, PANa: sodium polyacrylate, PAMNa: sodium polyacrylate maleate, and PEI: polyethyleneimine.

### <Preparation of Recycled Polishing Agent Slurry 29>

First, 1.0 L of the used polishing agent slurry 1 was filtered using a mesh filter with a pore diameter of 100 μm to remove a coarse foreign matter.

A 0.1 mol/L magnesium chloride aqueous solution was added to the polishing agent slurry at a supply rate of 10 mL/L with stirring, and the addition and the particle size measurement were repeated until the average particle size (D50) was doubled before the addition.

After the addition of the magnesium chloride aqueous solution was completed, the dispersion liquid was allowed to stand for 1 hour to separate it into a supernatant and a precipitate.

0.1 L of the slurry containing the precipitate was collected, and the concentration of the cerium oxide polishing agent and the concentration of the glass component contained in the collected slurry were measured by the above-mentioned method. The removal rate of the glass component was similarly measured with respect to the used polishing agent slurry 1.

### <Preparation of Recycled Polishing Agent Slurries 30 to 36>

### <Preparation of Used Polishing Agent Slurry 2>

In the preparation of the used polishing agent slurry 1, the used polishing agent slurry 2 was prepared in the same manner except that the total polishing amount of the glass was set to 5 g/L. The electrical conductivity value at 25° C. equivalent of the used polishing agent slurry 2 was 6.8 mS/cm.

### <Preparation of Recycled Polishing Agent Slurry 30>

### [Separation and Concentration Process]

First, 1.0 L of the collected used polishing agent slurry 2 was filtered using a mesh filter with a pore diameter of 100 μm to remove a coarse foreign matter.

Next, a dispersing agent (ammonium polyacrylate: PAA) was added in an amount of 2.5% by mass based on the cerium oxide polishing agent particles.

Further, a pH adjusting agent (ammonia water) was added to adjust the pH to 8.5, and then dispersion treatment was performed using an ultrasonic disperser.

After performing the ultrasonic dispersion treatment, the dispersion liquid was allowed to stand for 1 hour, separated into a supernatant and a precipitate by a natural sedimentation method, the supernatant liquid was discharged, and 0.1 L of the polishing agent slurry containing the precipitate was collected. In this way, the glass component was removed and the cerium oxide component was concentrated.

The concentration of the cerium oxide polishing agent and the concentration of the glass component contained in the collected polishing agent slurry were measured by the above-mentioned method.

Then, in the same manner as the preparation of the recycled polishing agent slurry 1, the recycled polishing agent slurry 30 was prepared according to the above-described polishing agent recycle process.

### <Preparation of Recycled Polishing Agent Slurries 31 to 33>

In the preparation of the recycled polishing agent slurry 1, the recycled polishing agent slurries were prepared in the same manner except that the preparation was done under the following conditions.

First, 1.0 L of the collected used polishing agent slurry 2 was filtered using a mesh filter with a pore diameter of 100 μm to remove a coarse foreign matter.

Next, the filtrate component containing the cerium oxide polishing agent was diluted 3 times (6 times, 10 times) in volume with pure water, and then stirred for 30 minutes using a stirrer.

After the above stirring treatment, a dispersing agent (ammonium polyacrylate: PAA) was added in an amount of 2.5% by mass based on the cerium oxide polishing agent particles, and a pH adjusting agent (ammonia water) was added to adjust the pH to 8.5. Thereafter, the dispersion treatment was performed using an ultrasonic disperser.

After performing the ultrasonic dispersion treatment, the dispersion liquid was allowed to stand for 1 hour, separated into a supernatant and a precipitate by a natural sedimentation method, the supernatant liquid was discharged, and 0.3 L (0.6 L, 1.0 L) of the polishing agent slurry containing the precipitate was collected. In this way, the glass component was removed and the cerium oxide component was concentrated.

The concentration of the cerium oxide polishing agent and the concentration of the glass component contained in the collected polishing agent slurry were measured by the above-mentioned method. The removal rate of the glass component was similarly measured with respect to the used polishing agent slurry 2.

Then, in the same manner as the preparation of the recycled polishing agent slurry 1, the recycled polishing agent slurries 31 to 33 were prepared according to the above-described polishing agent recycle process.

### <Preparation of Recycled Polishing Agent Slurries 34 and 35>

In the preparation of the recycled polishing agent slurry 1, the recycled polishing agent slurries were prepared in the same manner except that the preparation was done under the following conditions.

First, 1.0 L of the used recycled polishing agent slurry 2 was filtered using a mesh filter with a pore diameter of 100 μm to remove a coarse foreign matter.

Next, the filtrate component containing the cerium oxide polishing agent was diluted 2 times or 4 in volume with pure water, and then stirred for 30 minutes using a stirrer.

The agitated polishing agent slurry was filtered through a filter having a pore size of 1.0 μm to collect the solid content remaining on the filter, and then pure water was added to make 20 L, which was dispersed again with a stirrer. However, only the recycled polishing agent slurry 7 was filtered again with a 1.0 μm filter to collect the solid content, and then pure water was added to make 20 L, which was dispersed by a stirrer.

Next, a dispersing agent (ammonium polyacrylate: PAA) was added in an amount of 2.5% by mass based on the cerium oxide polishing agent particles.

Further, a pH adjusting agent (ammonia water) was added to adjust the pH to 8.5, and then dispersion treatment was performed using an ultrasonic disperser.

After performing the ultrasonic dispersion treatment, the dispersion liquid was allowed to stand for 1 hour, separated into a supernatant and a precipitate, and 0.1 L of the polishing agent slurry containing the precipitate was collected.

The concentration of the cerium oxide polishing agent and the concentration of the glass component contained in the collected polishing agent slurry were measured by the above-mentioned method. The removal rate of the glass component was similarly measured with respect to the used polishing agent slurry 2.

Then, in the same manner as the preparation of the recycled polishing agent slurry 1, the recycled polishing agent slurries 34 and 35 were prepared according to the above-described polishing agent recycle process.

### <Preparation of Recycled Polishing Agent Slurries 36>

First, 1.0 L of the used polishing agent slurry 2 was filtered using a mesh filter with a pore diameter of 100 μm to remove a coarse foreign matter.

A 0.1 mol/L magnesium chloride aqueous solution was added to the polishing agent slurry at a supply rate of 10 mL/L with stirring, and the addition and the particle size measurement were repeated until the average particle size (D50) was doubled before the addition.

After the addition of the magnesium chloride aqueous solution was completed, the dispersion liquid was allowed to stand for 1 hour to separate it into a supernatant and a precipitate.

0.1 L of the slurry containing the precipitate was collected, and the concentration of the cerium oxide polishing agent and the concentration of the glass component contained in the collected slurry were measured by the above-mentioned method. The removal rate of the glass component was similarly measured with respect to the used polishing agent slurry 2.

### <Preparation of Recycled Polishing Agent Slurries 37 to 39>

### <Preparation of Used Polishing Agent Slurry 3>

In the preparation of the used polishing agent slurry 1, the used polishing agent slurry 3 was prepared in the same manner except that the total polishing amount of the glass was set to 2 g/L. The electrical conductivity value at 25° C. equivalent of the used polishing agent slurry 3 was 2.9 mS/cm.

First, 1.0 L of the used polishing agent slurry 3 was filtered using a mesh filter with a pore diameter of 100 μm to remove a coarse foreign matter.

Next, the filtrate component containing the cerium oxide polishing agent was diluted 3 times (6 times, 10 times) in volume with pure water, and then stirred for 30 minutes using a stirrer.

After the above stirring treatment, a dispersing agent (ammonium polyacrylate: PAA) was added in an amount of 2.5% by mass based on the cerium oxide polishing agent particles, and a pH adjusting agent (ammonia water) was added to adjust the pH to 8.5. Thereafter, the dispersion treatment was performed using an ultrasonic disperser.

After performing the ultrasonic dispersion treatment, the dispersion liquid was allowed to stand for 1 hour, separated into a supernatant and a precipitate by a natural sedimentation method, the supernatant liquid was discharged, and 0.3 L (0.6 L, 1.0 L) of the polishing agent slurry containing the precipitate was collected. In this way, the glass component was removed and the cerium oxide component was concentrated.

The concentration of the cerium oxide polishing agent and the concentration of the glass component contained in the collected polishing agent slurry were measured by the above-mentioned method. The removal rate of the glass component was similarly measured with respect to the used polishing agent slurry 3.

Then, in the same manner as the preparation of the recycled polishing agent slurry 1, the recycled polishing agent slurries 37 to 39 were prepared according to the above-described polishing agent recycle process.

### <Preparation of Recycled Polishing Agent Slurries 40 and 41>

In the preparation of the recycled polishing agent slurry 1, the recycled polishing agent slurries were prepared under the following conditions.

First, 1.0 L of the used polishing agent slurry 3 was filtered using a mesh filter with a pore diameter of 100 μm to remove a coarse foreign matter.

Next, the filtrate component containing the cerium oxide polishing agent was diluted 2 times or 4 times in volume with pure water, and then stirred for 30 minutes using a stirrer.

The agitated polishing agent slurry was filtered through a filter having a pore size of 1.0 μm to collect the solid content remaining on the filter, and then pure water was added to make 20 L, which was dispersed again with a stirrer.

Next, a dispersing agent (ammonium polyacrylate: PAA) was added in an amount of 2.5% by mass based on the cerium oxide polishing agent particles.

Further, a pH adjusting agent (ammonia water) was added to adjust the pH to 8.5, and then dispersion treatment was performed using an ultrasonic disperser.

After performing the ultrasonic dispersion treatment, the dispersion liquid was allowed to stand for 1 hour, separated into a supernatant and a precipitate, and 0.1 L of the polishing agent slurry containing the precipitate was collected.

The concentration of the cerium oxide polishing agent and the concentration of the glass component contained in the collected polishing agent slurry were measured by the above-mentioned method.

Then, in the same manner as the preparation of the recycled polishing agent slurry 1, the recycled polishing agent slurries 40 and 41 were prepared according to the above-described polishing agent recycle process.

### <Preparation of Recycled Polishing Agent Slurry 42>

First, 1.0 L of the used polishing agent slurry 3 was filtered using a mesh filter with a pore diameter of 100 μm to remove a coarse foreign matter.

A 0.1 mol/L magnesium chloride aqueous solution was added to the polishing agent slurry at a supply rate of 10 mL/L with stirring, and the addition and the particle size measurement were repeated until the average particle size (D50) was doubled before the addition.

After the addition of the magnesium chloride aqueous solution was completed, the dispersion liquid was allowed to stand for 1 hour to separate it into a supernatant and a precipitate.

0.1 L of the slurry containing the precipitate was collected, and the concentration of the cerium oxide polishing agent and the concentration of the glass component contained in the collected slurry were measured by the above-mentioned method. The removal rate of the glass component was similarly measured with respect to the used polishing agent slurry 3.

Then, in the same manner as the preparation of the recycled polishing agent slurry 1, the recycled polishing agent slurry 42 was prepared according to the above-described polishing agent recycle process.

### <<Evaluation of Recycled Polishing Agent Slurry>>

### [Removal Rate of Glass Component]

The concentration of the cerium oxide polishing agent and the concentration of the glass component contained in the collected polishing agent slurry were measured by the above-described ICP emission spectroscopic plasma method (“ICP-AES”). The removal rate of the glass component was measured with respect to the used polishing agent slurry.

The removal rate of the glass component was calculated by the following formula.

[1−(Glass component concentration of recycled polishing agent slurry÷Cerium oxide polishing agent component concentration)÷(Cerium oxide polishing agent component concentration of used polishing agent slurry÷Cerium oxide polishing agent component concentration)]×100(%)

Next, the criteria for evaluation rank were as follows.

DD: Removal rate is less than 50%

CC: Removal rate is 50% or more and less than 80%

BB: Removal rate is 80% or more and less than 95%

AA: Removal rate is 95% or more

It is judged that the effect of the present invention is obtained when the removal rate is 50% or more. Preferably, the removal rate is 80% or more. Table I and Table II show the compositions of the recycled polishing agent slurries 1 to 42 and the removal rate of the glass component.

TABLE I

| | | | Desalting treatment | | | |
|---|---|---|---|---|---|---|
| Recycled | Used polishing agent slurry | | (Ion concentration reducing treatment) | | | |
| polishing | Concentration | Ion | | | | Ion |
| agent | of glass | concentration | Ion concentration reducing treatment | | | concentration |
| slurry No. | g/L | mS/cm | Dilution ratio | First time | Second time | mS/cm |
| 1 | 10 | 12.1 | None | — | — | 12.1 |
| 2 | 10 | 12.1 | 3 times dilution | — | — | 5.0 |
| 3 | 10 | 12.1 | 6 times dilution | — | — | 2.4 |
| 4 | 10 | 12.1 | 10 times dilution | — | — | 1.4 |
| 5 | 10 | 12.1 | 2 times dilution | *1 | — | 0.7 |
| 6 | 10 | 12.1 | 4 times dilution | *1 | — | 0.5 |
| 7 | 10 | 12.1 | 2 times dilution | *1 | *1 | 0.2 |
| 8 | 10 | 12.1 | 4 times dilution | *1 | — | 0.5 |
| 9 | 10 | 12.1 | 4 times dilution | *1 | — | 0.4 |
| 10 | 10 | 12.1 | 4 times dilution | *1 | — | 0.4 |
| 11 | 10 | 12.1 | 4 times dilution | *1 | — | 0.5 |
| 12 | 10 | 12.1 | 4 times dilution | *1 | — | 0.6 |
| 13 | 10 | 12.1 | 4 times dilution | *1 | — | 0.5 |
| 14 | 10 | 12.1 | 4 times dilution | *1 | — | 0.5 |
| 15 | 10 | 12.1 | 4 times dilution | *1 | — | 0.5 |
| 16 | 10 | 12.1 | 4 times dilution | *1 | — | 0.4 |
| 17 | 10 | 12.1 | 4 times dilution | *1 | — | 0.4 |
| 18 | 10 | 12.1 | 4 times dilution | *1 | — | 0.5 |
| 19 | 10 | 12.1 | 4 times dilution | *1 | — | 0.5 |
| 20 | 10 | 12.1 | 4 times dilution | *1 | — | 0.6 |
| 21 | 10 | 12.1 | 4 times dilution | *1 | — | 0.5 |

| | After dispersion of cerium oxide | | | | | Evaluation | | |
|---|---|---|---|---|---|---|---|---|
| Recycled | abrasive grains and glass component | | | | | Removal | | |
| polishing | pH | Dispersion agent | | | | rate of glass | | |
| agent | adjusting | | Addition amount | | Separation | component | | |
| slurry No. | agent | Type | (% by mass) | pH | method | (%) | Rank | Remarks |
| 1 | NH₃ | PAA | 2.5 | 8.5 | *2 | 3.5 | DD | *4 |
| 2 | NH₃ | PAA | 2.5 | 8.5 | *2 | 53.2 | CC | *3 |
| 3 | NH₃ | PAA | 2.5 | 8.5 | *2 | 82.1 | BB | *3 |
| 4 | NH₃ | PAA | 2.5 | 8.5 | *2 | 86.0 | BB | *3 |
| 5 | NH₃ | PAA | 2.5 | 8.5 | *2 | 90.3 | BB | *3 |
| 6 | NH₃ | PAA | 2.5 | 8.5 | *2 | 92.1 | BB | *3 |
| 7 | NH₃ | PAA | 2.5 | 8.5 | *2 | 95.3 | AA | *3 |
| 8 | H₂SO₄ | PAA | 2.5 | 6.1 | *2 | 67.2 | CC | *3 |
| 9 | NH₃ | PAA | 2.5 | 7.5 | *2 | 78.9 | CC | *3 |
| 10 | NH₃ | PAA | 2.5 | 8.0 | *2 | 85.2 | BB | *3 |
| 11 | NH₃ | PAA | 2.5 | 8.5 | *2 | 93.1 | BB | *3 |
| 12 | NH₃ | PAA | 2.5 | 8.9 | *2 | 91.2 | BB | *3 |
| 13 | NH₃ | PAA | 2.5 | 9.2 | *2 | 92.8 | BB | *3 |
| 14 | NH₃ | [symbol] | [symbol] | 8.5 | *2 | 6.3 | DD | *4 |
| 15 | NH₃ | PAA | 0.1 | 8.5 | *2 | 62.3 | CC | *3 |
| 16 | NH₃ | PAA | 0.5 | 8.5 | *2 | 88.3 | BB | *3 |
| 17 | NH₃ | PAA | 1 | 8.5 | *2 | 89.1 | BB | *3 |
| 18 | NH₃ | PAA | 2.5 | 8.5 | *2 | 94.3 | BB | *3 |
| 19 | NH₃ | PAA | 5 | 8.5 | *2 | 93.8 | BB | *3 |
| 20 | TEA | PAA | 2.5 | 8.5 | *2 | 90.2 | BB | *3 |
| 21 | NaOH | PAA | 2.5 | 8.5 | *2 | 92.0 | BB | *3 |

*1: Filtration/Redispersion
*2: Natural sedimentation
*3: Inventive Example
*4: Comparative Example

TABLE II

| | | | Desalting treatment | | | |
|---|---|---|---|---|---|---|
| Recycled | Used polishing agent slurry | | (Ion concentration reducing treatment) | | | |
| polishing | Concentration | Ion | | | | Ion |
| agent | of glass | concentration | Ion concentration reducing treatment | | | concentration |
| slurry No. | g/L | mS/cm | Dilution ratio | First time | Second time | mS/cm |
| 22 | 10 | 12.1 | 4 times dilution | *1 | — | 0.4 |
| 23 | 10 | 12.1 | 4 times dilution | *1 | — | 0.5 |
| 24 | 10 | 12.1 | 4 times dilution | *1 | — | 0.5 |
| 25 | 10 | 12.1 | 4 times dilution | *1 | — | 0.4 |
| 26 | 10 | 12.1 | 4 times dilution | *1 | — | 0.5 |
| 27 | 10 | 12.1 | 4 times dilution | *1 | — | 0.5 |
| 28 | 10 | 12.1 | 4 times dilution | *1 | — | 0.6 |
| 29 | 10 | 12.1 | None | — | — | 12.1 |
| 30 | 5 | 6.8 | None | — | — | 6.8 |
| 31 | 5 | 6.8 | 3 times dilution | — | — | 2.6 |
| 32 | 5 | 6.8 | 6 times dilution | — | — | 1.3 |
| 33 | 5 | 6.8 | 10 times dilution | — | — | 0.8 |
| 34 | 5 | 6.8 | 2 times dilution | *1 | — | 0.4 |
| 35 | 5 | 6.8 | 4 times dilution | *1 | — | 0.2 |
| 36 | 5 | 6.8 | None | — | | 6.8 |
| 37 | 2 | 2.9 | 3 times dilution | — | — | 1.0 |
| 38 | 2 | 2.9 | 6 times dilution | — | — | 0.6 |
| 39 | 2 | 2.9 | 10 times dilution | — | — | 0.3 |
| 40 | 2 | 2.9 | 2 times dilution | *1 | — | 0.2 |
| 41 | 2 | 2.9 | 4 times dilution | *1 | — | 0.1 |
| 42 | 2 | 2.9 | None | — | — | 2.9 |

| | After dispersion of cerium oxide | | | | | Evaluation | | |
|---|---|---|---|---|---|---|---|---|
| Recycled | abrasive grains and glass component | | | | | Removal | | |
| polishing | pH | Dispersion agent | | | | rate of glass | | |
| agent | adjusting | | Addition amount | | Separation | component | | |
| slurry No. | agent | Type | (% by mass) | pH | method | (%) | Rank | Remarks |
| 22 | KOH | PAA | 2.5 | 8.5 | *2 | 91.1 | BB | *3 |
| 23 | NH₃ | PANa | 2.5 | 8.5 | *2 | 90.8 | BB | *3 |
| 24 | NH₃ | PAMNa | 2.5 | 8.5 | *2 | 93.4 | BB | *3 |
| 25 | NH₃ | PEI | 2.5 | 8.5 | *2 | 91.0 | BB | *3 |
| 26 | NH₃ | PAA | 2.5 | 8.5 | *2 | 92.1 | BB | *3 |
| 27 | NH₃ | PAA | 2.5 | 8.5 | *2 | 94.2 | BB | *3 |
| 28 | NH₃ | PAA | 2.5 | 8.5 | *2 | 90.5 | BB | *3 |
| 29 | None | None | None | None | Addition | 2.7 | DD | *4 |
| | | | | | of salt | | | |
| 30 | NH₃ | PAA | 2.5 | 8.5 | *2 | 4.1 | DD | *4 |
| 31 | NH₃ | PAA | 2.5 | 8.5 | *2 | 80.1 | BB | *3 |
| 32 | NH₃ | PAA | 2.5 | 8.5 | *2 | 89.2 | BB | *3 |
| 33 | NH₃ | PAA | 2.5 | 8.5 | *2 | 91.2 | BB | *3 |
| 34 | NH₃ | PAA | 2.5 | 8.5 | *2 | 93.3 | BB | *3 |
| 35 | NH₃ | PAA | 2.5 | 8.5 | *2 | 92.6 | BB | *3 |
| 36 | None | None | None | None | Addition | 4.6 | DD | *4 |
| | | | | | of salt | | | |
| 37 | NH₃ | PAA | 2.5 | 8.5 | *2 | 90.0 | BB | *3 |
| 38 | NH₃ | PAA | 2.5 | 8.5 | *2 | 93.2 | BB | *3 |
| 39 | NH₃ | PAA | 2.5 | 8.5 | *2 | 94.9 | BB | *3 |
| 40 | NH₃ | PAA | 2.5 | 8.5 | *2 | 96.7 | AA | *3 |
| 41 | NH₃ | PAA | 2.5 | 8.5 | *2 | 97.2 | AA | *3 |
| 42 | None | None | None | None | Addition | 43.1 | DD | *4 |
| | | | | | of salt | | | |

*1: Filtration/Redispersion
*2: Natural sedimentation
*3: Inventive Example
*4: Comparative Example

From Tables I and II, it was found the following. By performing the first process containing: the desalting treatment process of removing the dissolved glass derived from the object to be polished, the components dissolved from the glass, and the ionic component such as the pH adjusting agent from the used polishing agent slurry used for polishing the glass; and the dispersion treatment process of adding the pH adjusting agent and the dispersing agent, it was found that the removal rate of the glass component was remarkably improved, and a polishing agent recycle method having excellent separability between the abrasive grain component containing cerium oxide and the glass component was obtained.

### Example 2

In Example 2, an example relating to the dispersion treatment process in which only the pH adjuster is added, and the separation and concentration treatment process in the first step, which is the alternative method, will be described.

### <Preparation of Recycled Polishing Agent Slurries 43 to 47>

### <Preparation of Used Polishing Agent Slurry 3>

In the preparation of the used polishing agent slurry 1, the used polishing agent slurry 3 was prepared in the same manner except that the total polishing amount of the glass was set to 2 g/L. The electrical conductivity value at 25° C. equivalent of the used polishing agent slurry 3 was 2.9 mS/cm.

First, 1.0 L of the used polishing agent slurry 3 was filtered using a mesh filter with a pore diameter of 100 μm to remove a coarse foreign matter.

Next, the filtrate component containing the cerium oxide polishing agent was diluted 10 times in volume with pure water, and then stirred for 30 minutes using a stirrer. The electrical conductivity value at 25° C. equivalent of the desalted used polishing agent slurry was 0.3 mS/cm.

After the stirring treatment, a pH adjusting agent (ammonia water) was added to adjust the pH value at 25° C. equivalent to 7.0 (7.5, 8.0, 8.5, 9.0), then, dispersion treatment was performed using an ultrasonic disperser.

After performing the ultrasonic dispersion treatment, the dispersion liquid was allowed to stand for 1 hour, separated into a supernatant and a precipitate by a natural sedimentation method, the supernatant liquid was discharged, and 1.0 L of the polishing agent slurry containing the precipitate was collected. In this way, the glass component was removed and the cerium oxide component was concentrated.

The concentration of the cerium oxide polishing agent and the concentration of the glass component contained in the collected polishing agent slurry were measured by the above-mentioned method. The removal rate of the glass component was similarly measured with respect to the used polishing agent slurry 3.

Then, in the same manner as the preparation of the recycled polishing agent slurry 1, the recycled polishing agent slurries 43 to 47 were prepared according to the above-described polishing agent recycle process.

### <Preparation of Recycled Polishing Agent Slurries 48 to 52>

First, 1.0 L of the used polishing agent slurry 3 was filtered using a mesh filter with a pore diameter of 100 μm to remove a coarse foreign matter.

Next, the filtrate component containing the cerium oxide polishing agent was diluted 10 times in volume with pure water, and then stirred for 30 minutes using a stirrer.

The agitated polishing agent slurry was filtered through a 1.0 μm filter, and the solid content remaining on the filter was collected. Then, pure water was added to make 20 L, which was dispersed again with a stirrer. The electrical conductivity value at 25° C. equivalent of the desalted used polishing agent slurry was 0.2 mS/cm.

Further, a pH adjusting agent (ammonia water) was added to adjust the pH to 7.0 (7.5, 8.0, 8.5, and 9.0), then dispersion treatment was performed using an ultrasonic disperser.

After performing the ultrasonic dispersion treatment, the dispersion liquid was allowed to stand for 1 hour, separated into a supernatant and a precipitate, and 1.0 L of the polishing agent slurry containing the precipitate was collected.

The concentration of the cerium oxide polishing agent and the concentration of the glass component contained in the collected polishing agent slurry were measured by the above-mentioned method.

Then, in the same manner as the preparation of the recycled polishing agent slurry 1, the recycled polishing agent slurries 48 to 52 were prepared according to the above-described polishing agent recycle process.

### <Preparation of Recycled Polishing Agent Slurries 53 to 57>

First, 1.0 L of the used polishing agent slurry 3 was filtered using a mesh filter with a pore diameter of 100 μm to remove a coarse foreign matter.

Next, the filtrate component containing the cerium oxide polishing agent was diluted 4 times in volume with pure water, and then stirred for 30 minutes using a stirrer.

The agitated polishing agent slurry was filtered through a 1.0 μm filter, and the solid content remaining on the filter was collected. Then, pure water was added to make 20 L, which was dispersed again with a stirrer. The electrical conductivity value at 25° C. equivalent of the desalted used polishing agent slurry was 0.1 mS/cm.

Further, a pH adjusting agent (ammonia water) was added to adjust the pH to 7.0 (7.5, 8.0, 8.5, and 9.0), then dispersion treatment was performed using an ultrasonic disperser.

After performing the ultrasonic dispersion treatment, the dispersion liquid was allowed to stand for 1 hour, separated into a supernatant and a precipitate, and 1.0 L of the polishing agent slurry containing the precipitate was collected.

The concentration of the cerium oxide polishing agent and the concentration of the glass component contained in the collected polishing agent slurry were measured by the above-mentioned method.

Then, in the same manner as the preparation of the recycled polishing agent slurry 1, the recycled polishing agent slurries 53 to 57 were prepared according to the above-described polishing agent recycle process.

### <Preparation of Recycled Polishing Agent Slurry 58>

First, 1.0 L of the used polishing agent slurry 3 was filtered using a mesh filter with a pore diameter of 100 μm to remove a coarse foreign matter.

Next, the filtrate component containing the cerium oxide polishing agent was diluted 10 times in volume with pure water, and then stirred for 30 minutes using a stirrer. The electrical conductivity value at 25° C. equivalent of the desalted used polishing agent slurry was 0.3 mS/cm.

After the stirring treatment, a pH adjusting agent (ammonia water) was added to adjust the pH value at 25° C. equivalent to 9.0, then, dispersion treatment was performed using an ultrasonic disperser.

After the dispersion treatment, as a second process, a pH adjusting agent (aqueous sulfuric acid solution) was added to adjust the pH value at 25° C. equivalent to 7.0, and then stirred for 10 minutes using a stirrer. The dispersion liquid was allowed to stand for 1 hour, separated into a supernatant and a precipitate by a natural sedimentation method, and the supernatant liquid was discharged to collect 1.0 L of the polishing agent slurry containing the precipitate. Thus, the glass component was removed and the cerium oxide component was concentrated.

The concentration of the cerium oxide polishing agent and the concentration of the glass component contained in the collected polishing agent slurry were measured by the above-mentioned method. The removal rate of the glass component was similarly measured with respect to the used polishing agent slurry 3.

Then, in the same manner as the preparation of the recycled polishing agent slurry 1, the recycled polishing agent slurry 58 was prepared according to the above-described polishing agent recycle process.

### <Preparation of Recycled Polishing Agent Slurry 59>

First, 1.0 L of the used polishing agent slurry 3 was filtered using a mesh filter with a pore diameter of 100 μm to remove a coarse foreign matter.

Next, the filtrate component containing the cerium oxide polishing agent was diluted 10 times in volume with pure water, and then stirred for 30 minutes using a stirrer.

The agitated polishing agent slurry was filtered through a 1.0 μm filter, and the solid content remaining on the filter was collected. Then, pure water was added to make 20 L, which was dispersed again with a stirrer. The electrical conductivity value at 25° C. equivalent of the desalted used polishing agent slurry was 0.2 mS/cm.

Further, a pH adjusting agent (ammonia water) was added to adjust the pH value at 25° C. equivalent to 9.0, then, dispersion treatment was performed using an ultrasonic disperser.

After the dispersion treatment, a pH adjusting agent (aqueous sulfuric acid solution) was added to adjust the pH value at 25° C. equivalent to 7.0, and then stirred for 10 minutes using a stirrer. The dispersion liquid was allowed to stand for 1 hour, separated into a supernatant and a precipitate by a natural sedimentation method, and the supernatant liquid was discharged to collect 1.0 L of the polishing agent slurry containing the precipitate. Thus, the glass component was removed and the cerium oxide component was concentrated.

The concentration of the cerium oxide polishing agent and the concentration of the glass component contained in the collected polishing agent slurry were measured by the above-mentioned method. The removal rate of the glass component was similarly measured with respect to the used polishing agent slurry 3.

Then, in the same manner as the preparation of the recycled polishing agent slurry 1, the recycled polishing agent slurry 59 was prepared according to the above-described polishing agent recycle process.

### <Preparation of Recycled Polishing Agent Slurry 60>

First, 1.0 L of the used polishing agent slurry 3 was filtered using a mesh filter with a pore diameter of 100 μm to remove a coarse foreign matter.

Next, the filtrate component containing the cerium oxide polishing agent was diluted 4 times in volume with pure water, and then stirred for 30 minutes using a stirrer.

The agitated polishing agent slurry was filtered through a 1.0 μm filter, and the solid content remaining on the filter was collected. Then, pure water was added to make 20 L, which was dispersed again with a stirrer. The electrical conductivity value at 25° C. equivalent of the desalted used polishing agent slurry was 0.1 mS/cm.

Further, a pH adjusting agent (ammonia water) was added to adjust the pH value at 25° C. equivalent to 9.0, then, dispersion treatment was performed using an ultrasonic disperser.

After the dispersion treatment, a pH adjusting agent (aqueous sulfuric acid solution) was added to adjust the pH value at 25° C. equivalent to 7.0, and then stirred for 10 minutes using a stirrer. The dispersion liquid was allowed to stand for 1 hour, separated into a supernatant and a precipitate by a natural sedimentation method, and the supernatant liquid was discharged to collect 1.0 L of the polishing agent slurry containing the precipitate. Thus, the glass component was removed and the cerium oxide component was concentrated.

The concentration of the cerium oxide polishing agent and the concentration of the glass component contained in the collected polishing agent slurry were measured by the above-mentioned method. The removal rate of the glass component was similarly measured with respect to the used polishing agent slurry 3.

Then, in the same manner as the preparation of the recycled polishing agent slurry 1, the recycled polishing agent slurry 60 was prepared according to the above-described polishing agent recycle process.

### <<Evaluation of Recycled Polishing Agent Slurry>>

### [Removal Rate of Glass Component]

The concentration of the cerium oxide polishing agent and the concentration of the glass component contained in the collected polishing agent slurry were measured by the above-described ICP emission spectroscopic plasma method (“ICP-AES”). The removal rate of the glass component was measured with respect to the used polishing agent slurry.

The removal rate of the glass component was calculated by the following formula.

[1−(Glass component concentration of recycled polishing agent slurry÷Cerium oxide polishing agent component concentration)÷(Cerium oxide polishing agent component concentration of used polishing agent slurry÷Cerium oxide polishing agent component concentration)]×100(%)

Next, the criteria for evaluation rank were as follows.

DD: Removal rate is less than 50%

CC: Removal rate is 50% or more and less than 80%

BB: Removal rate is 80% or more and less than 95%

AA: Removal rate is 95% or more

It is judged that the effect of the present invention is obtained when the removal rate is 50% or more. Preferably, the removal rate is 80% or more.

Table III shows the compositions of the recycled polishing agent slurries 43 to 60 and the removal rate of the glass component.

TABLE III

| | | | Desalting treatment | | | |
|---|---|---|---|---|---|---|
| Recycled | Used polishing agent slurry | | (Ion concentration reducing treatment) | | | |
| polishing | Concentration | Ion | | | | Ion |
| agent | of glass | concentration | Ion concentration reducing treatment | | | concentration |
| slurry No. | g/L | mS/cm | Dilution ratio | First time | Second time | mS/cm |
| 43 | 2 | 2.9 | 10 times dilution | — | — | 0.3 |
| 44 | 2 | 2.9 | 10 times dilution | — | — | 0.3 |
| 45 | 2 | 2.9 | 10 times dilution | — | — | 0.3 |
| 46 | 2 | 2.9 | 10 times dilution | — | — | 0.3 |
| 47 | 2 | 2.9 | 10 times dilution | — | — | 0.3 |
| 48 | 2 | 2.9 | 2 times dilution | *1 | — | 0.2 |
| 49 | 2 | 2.9 | 2 times dilution | *1 | — | 0.2 |
| 50 | 2 | 2.9 | 2 times dilution | *1 | — | 0.2 |
| 51 | 2 | 2.9 | 2 times dilution | *1 | — | 0.2 |
| 52 | 2 | 2.9 | 2 times dilution | *1 | — | 0.2 |
| 53 | 2 | 2.9 | 4 times dilution | *1 | — | 0.1 |
| 54 | 2 | 2.9 | 4 times dilution | *1 | — | 0.1 |
| 55 | 2 | 2.9 | 4 times dilution | *1 | — | 0.1 |
| 56 | 2 | 2.9 | 4 times dilution | *1 | — | 0.1 |
| 57 | 2 | 2.9 | 4 times dilution | *1 | — | 0.1 |
| 58 | 2 | 2.9 | 10 times dilution | — | — | 0.3 |
| 59 | 2 | 2.9 | 2 times dilution | *1 | — | 0.2 |
| 60 | 2 | 2.9 | 4 times dilution | *1 | — | 0.1 |

| | After dispersion of cerium oxide | | | | | Evaluation | | |
|---|---|---|---|---|---|---|---|---|
| Recycled | abrasive grains and glass component | | | | | Removal | | |
| polishing | pH | Dispersion agent | | | | rate of glass | | |
| agent | adjusting | | Addition amount | | Separation | component | | |
| slurry No. | agent | Type | (% by mass) | pH | method | (%) | Rank | Remarks |
| 43 | NH₃ | None | None | 7.0 | *2 | 10.9 | DD | *5 |
| 44 | NH₃ | None | None | 7.5 | *2 | 15.4 | DD | *5 |
| 45 | NH₃ | None | None | 8.0 | *2 | 58.8 | CC | *4 |
| 46 | NH₃ | None | None | 8.5 | *2 | 63.4 | CC | *4 |
| 47 | NH₃ | None | None | 9.0 | *2 | 77.9 | CC | *4 |
| 48 | NH₃ | None | None | 7.0 | *2 | 18.8 | DD | *5 |
| 49 | NH₃ | None | None | 7.5 | *2 | 40.1 | DD | *5 |
| 50 | NH₃ | None | None | 8.0 | *2 | 73.2 | CC | *4 |
| 51 | NH₃ | None | None | 8.5 | *2 | 83.7 | BB | *4 |
| 52 | NH₃ | None | None | 9.0 | *2 | 93.5 | BB | *4 |
| 53 | NH₃ | None | None | 7.0 | *2 | 21.1 | DD | *5 |
| 54 | NH₃ | None | None | 7.5 | *2 | 48.5 | DD | *5 |
| 55 | NH₃ | None | None | 8.0 | *2 | 83.9 | BB | *4 |
| 56 | NH₃ | None | None | 8.5 | *2 | 91.0 | BB | *4 |
| 57 | NH₃ | None | None | 9.0 | *2 | 95.8 | AA | *4 |
| 58 | NH₃ | None | None | 9.0 | *3 | 65.1 | CC | *4 |
| 59 | NH₃ | None | None | 9.0 | *3 | 80.8 | BB | *4 |
| 60 | NH₃ | None | None | 9.0 | *3 | 90.2 | BB | *4 |

*1: Filtration/Redispersion
*2: Natural sedimentation
*3: Agglomeration precipitation (pH 7.0)
*4: inventive Example
*5: Comparative Example

From the results described in Table III, it was found the following. From the used polishing agent slurry used for polishing glass, the dissolved glass component derived from the object to be polished, the component dissolved from the glass itself, and the ionic component such as pH adjusting agent were subjected to the desalting treatment so that the electrical conductivity value at 25° C. equivalent to be 0.3 mS/cm or less, then, by adopting a dispersion treatment process in which the pH value at 25° C. equivalent is adjusted to a range of 8.0 or more. It was found that the removal rate of the glass component was remarkably improved. Therefore, in the first process, there was obtained a method for recycling a polishing agent, which is excellent in separability between an abrasive grain component containing cerium oxide and a glass component, without adding a dispersing agent.

According to the evaluation results of the recycled polishing agent slurries 50 to 60, it was found the following. As a second process, a pH adjusting agent is added to the dispersion-treated polishing agent slurry, and the pH value at 25° C. equivalent is adjusted from alkaline (9.0) to neutral (6.0 or more and less than 8.0). Thereby, the abrasive grain component containing cerium oxide is aggregated and precipitated, and the separation and concentration treatment process is performed. It was found to obtain a method for recycling a polishing agent having a high removal rate of the glass component and excellent separation between the abrasive grain component containing cerium oxide and the glass component.

Although embodiments of the present invention have been described and illustrated in detail, the disclosed embodiments are made for purposes of illustration and example only and not limitation. The scope of the present invention should be interpreted by terms of the appended claims.

### DESCRIPTION OF SYMBOLS

1: Polishing device
2: Polishing surface plate
3: Object to be polished
4: Polishing agent liquid
5: Slurry nozzle
7: Washing water
8: Washing water jet nozzle
10: Washing liquid containing polishing agent
13: Used polishing agent slurry (mother liquid)
14: Adjustment kettle
15: Stirrer
16a: Diluting water tank
16b: pH Adjusting agent supply tank
16c: Dispersing agent supply tank
17: Diluting water
18: Mixture of an abrasive grain component containing cerium oxide and a glass component
19: Dispersion mixed with an abrasive grain component containing cerium oxide and a glass component
20: Separated concentrate liquid of an abrasive grain component containing cerium oxide
21: Supernatant liquid containing a glass component
22: Component adjusting liquid
23: Recycled polishing agent slurry

What is claimed is:

1. A method for recycling a polishing agent slurry to remove a constituent component of an object to be polished from a used polishing agent slurry containing a polishing agent component and the constituent component of the object to be polished, and to collect and recycle the polishing agent component, the method comprising:
a first process including:
a slurry collecting process of collecting the used polishing agent slurry discharged from a polishing device;
a desalting treatment process of reducing an ion concentration of the collected polishing agent slurry; and
a dispersion treatment process of dispersing the polishing agent component and the constituent component of the object to be polished by adding a pH adjusting agent and a dispersing agent to the desalted polishing agent slurry; and, after the first process,
a second process of preparing a recycled polishing agent slurry from the polishing agent component by separating the polishing agent component and the constituent component of the object to be polished.

2. The method for recycling a polishing agent slurry according to claim 1, wherein the second process contains: a separation and concentration process of separating the polishing agent component and the constituent component of the object to be polished by natural sedimentation, centrifugation, sedimentation separation by adding a salt, or filter filtration; and
a polishing agent recycle process of preparing a recycled polishing agent slurry from the separated and concentrated polishing agent component.

3. The method for recycling a polishing agent slurry according to claim 1, wherein in the desalting treatment process, desalting treatment is performed so that an ion concentration of the used polishing agent slurry becomes 5.0 mS/cm or less as an electrical conductivity value at 25° C. equivalent.

4. The method for recycling a polishing agent slurry according to claim 3, wherein the desalting treatment is performed so that the ion concentration of the used polishing agent slurry becomes 1.0 mS/cm or less as an electrical conductivity value at 25° C. equivalent.

5. The method for recycling a polishing agent slurry according to claim 1, wherein in the dispersion treatment process of the first process, the pH value at 25° C. equivalent of the used polishing agent is adjusted to 6.0 or more by the pH adjusting agent, and the dispersing agent is added in the range of 0.1 to 5.0% by mass with respect to a mass of the polishing agent contained in the used polishing agent slurry.

6. The method for recycling a polishing agent slurry according to claim 1, wherein the pH adjusting agent is one of an inorganic acid, a carboxylic acid, an amine base or ammonium hydroxide, and the dispersing agent is one of a water-soluble anionic dispersing agent, a water-soluble cationic dispersing agent or a water-soluble amphoteric dispersing agent.

7. A method for recycling a polishing agent slurry to remove a constituent component of an object to be polished from a used polishing agent slurry containing a polishing agent component and the constituent component of the object to be polished, and to collect and recycle the polishing agent component, the method comprising:
a first process including:
a slurry collecting process of collecting the used polishing agent slurry discharged from a polishing device;
a desalting treatment process of adjusting an ion concentration of the collected polishing agent slurry to be 0.3 mS/cm or less as an electrical conductivity value at 25° C. equivalent; and
a dispersion treatment process of dispersing the polishing agent component and the constituent component of the object to be polished by adding a pH adjusting agent to the desalted polishing agent slurry to adjust a pH value of the used polishing agent slurry at 25° C. equivalent to be 8.0 or more; and
after the first process, a second process of preparing a recycled polishing agent slurry from the polishing agent component by separating the polishing agent component and the constituent component of the object to be polished.

8. The method for recycling a polishing agent slurry according to claim 7,
wherein the second process contains:
a separation and concentration process of separating the polishing agent component and the constituent component of the object to be polished by natural sedimentation, centrifugation, sedimentation separation by adding a salt, filter filtration, or agglomeration precipitation by pH value adjustment; and
a polishing agent recycle process of preparing a recycled polishing agent slurry from the separated and concentrated polishing agent component.

9. The method for recycling a polishing agent slurry according to claim 7,
wherein the desalting treatment is performed so that an ion concentration of the used polishing agent slurry becomes 1.0 mS/cm or less as an electrical conductivity value at 25° C. equivalent.

10. The method for recycling a polishing agent slurry according to claim 8, wherein in the second process, the agglomeration precipitation is performed by adjusting a pH value at 25° C. equivalent of the used polishing agent slurry in the range of 6.0 or more and less than 8.0.

11. The method for recycling a polishing agent slurry according to claim 7, wherein the pH adjusting agent is one of an inorganic acid, a carboxylic acid, an amine base or ammonium hydroxide,

12. A recycle system of a polishing agent slurry by using the method for recycling a polishing agent slurry according to claim 1 to remove a constituent component of an object to be polished from a used polishing agent slurry containing a polishing agent component and the constituent component of the object to be polished, and to collect and recycle the polishing agent component,
wherein the recycle system contains:
a polishing process unit having a polishing device;
a polishing agent slurry supply process unit having a slurry supply tank for supplying the polishing agent slurry to the polishing process unit;
a slurry collecting process unit having a collecting mixture liquid tank for collecting the used polishing agent slurry discharged from the polishing device;
a desalting treatment process unit having a diluting water supply tank for reducing the ion concentration of the collected polishing agent slurry, a desalting treatment tank, a desalting treatment apparatus, and an ion concentration measuring part for measuring the ion concentration;
a dispersion treatment process unit having an additive supply tank for supplying a pH adjusting agent and a dispersing agent to the desalted polishing agent slurry, a dispersion tank for dispersing the polishing agent component and the constituent component of the object to be polished, and a dispersion treatment device;
a separation and concentration process unit having a separation and concentration tank that separates and concentrates the polishing agent component and the constituent component of the object to be polished; and
a polishing agent recycle process unit having a polishing agent slurry preparation tank having an additive supply tank for adding a pH adjusting agent and a dispersing agent to the separated and concentrated polishing agent component.

13. The recycle system of a polishing agent slurry according to claim 12, wherein the separation and concentration process unit has one of a natural sedimentation device, a centrifugal separation device, a device for sedimentation and separation by adding a salt, a filter filtration device, or an agglomeration precipitation device by pH value adjustment.
